(19) United States
(12) Patent Application Publication
(10) Pub. No.: US 2008/0199625 A1
(43) Pub. Date: Aug. 21, 2008

(54) Colored coating composition

(75) Inventor: Norio Niwa, Hiratsuka-shi (JP)

Correspondence Address: KRATZ, QUINTOS & HANSON, LLP, 1420 K Street, N.W., Suite 400, WASHINGTON, DC, 20005, US

(73) Assignee: KANSAI PAINT CO., LTD., Amagasaki-shi (JP)

(21) Appl. No.: 12/071,006

(22) Filed: Feb. 14, 2008

(30) Foreign Application Priority Data
Feb. 16, 2007 (JP) 2007-36143

(51) Int. Cl. B05D 5/06; C08K 5/10

(52) U.S. Cl. 427/407.1; 524/601; 427/466

(57) ABSTRACT

The present invention provides a colored coating composition and coating film-forming method that are capable of forming a multilayer coating film having excellent appearance with excellent smoothness, high flip-flop effect, and little metallic mottling.

The colored coating composition comprises:

(A) a hydroxy-containing resin,
(B) a curing agent,
(C) a diester compound represented by Formula (1)

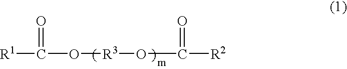

wherein R¹ and R² are each independently a C₄₋₁₈ hydrocarbon group, R³ is a C₂₋₄ alkylene group, m is an integer of 3 to 25, and m oxyalkylene units (R³—O) may be the same or different,
(D1) a coloring pigment, and
(D2) an extender pigment;
the total amount of the coloring pigment (D1) and the extender pigment (D2) being 40 to 180 parts by mass per 100 parts by mass of the hydroxy-containing resin (A) and the curing agent (B) in total.

### TECHNICAL FIELD

The present invention relates to a colored coating composition and a method for forming a coating film using the same.

### BACKGROUND ART

On motor vehicle bodies, and in particular on their outer panels, multilayer coating films each comprising an undercoating film with excellent anticorrosion properties, an intermediate coating film with excellent smoothness and chipping resistance, and an overcoating film with excellent appearance, are generally formed in order to impart high anticorrosion properties, excellent appearance, etc.

Of these coating films, the overcoating film can be formed by various methods, usually using a colored coating composition, a colored base coating composition, a clear coating composition, etc. Examples of such methods include one-coat one-bake methods in which a colored coating composition is applied and then baked and cured; two-coat one-bake methods in which a colored base coating composition containing a luster pigment, a coloring pigment, or like pigment is applied, and a clear coating composition is applied over the resulting uncured colored base coating, and then the colored base coating and clear coating are simultaneously baked and cured; three-coat one-bake methods in which a colored base coating composition containing a coloring pigment is applied, a luster base coating composition containing a luster pigment with light interference properties, and the like is applied over the resulting uncured colored base coating, a clear coating composition is applied over the resulting luster base coating, and then the coloring base coating, luster base coating, and clear coating are simultaneously baked and cured; etc. The one-coat one-bake methods are often used for forming solid color coatings in white, black, and the like. The two-coat one-bake methods are often used for forming metallic color coatings containing luster pigments, such as aluminum pigments and the like. The three-coat one-bake methods are often used for forming so-called pearlescent coatings having light interference patterns.

Heretofore, in many cases, organic solvent-based coating compositions have been used as the above-mentioned colored coating compositions, colored base coating compositions, and luster base coating compositions. However, since the organic solvents in these coating compositions evaporate and cause environmental pollution during the baking of the applied compositions, aqueous coating compositions, which cause less environmental pollution, have been increasingly employed in recent years.

However, coating films obtained using aqueous coating compositions are generally inferior in smoothness and other properties to those obtained using organic solvent-based coating compositions. When using aqueous coating compositions containing luster pigments, there are also problems in that the flip-flop effect is lower and metallic mottling is more likely to occur, than in the case of using organic solvent-based coating compositions.

To solve these problems, Japanese Unexamined Patent Publication No. 2003-286450 discloses an aqueous coating composition comprising an aqueous resin dispersion and a luster material, the aqueous resin dispersion being obtained by solution-polymerizing a monomer mixture A having an acid value of 30 to 150 and a hydroxy value of 10 to 100 in water to obtain an aqueous solution resin for emulsion polymerization, and then emulsion-polymerizing a monomer mixture B having an acid value of up to 20 and a hydroxy value of up to 100 to synthesize a core resin in the aqueous solution resin for emulsion polymerization, which serves as a protective colloid. The aqueous coating composition can form a coating film having good appearance, and in particular, an excellent flip-flop effect. However, the coating film formed using the aqueous coating composition has poor smoothness and may have metallic mottling.

Japanese Unexamined Patent Publication No. 1995-207220 discloses an aqueous coating composition that comprises, as main components, (A) an aqueous base resin and (B) a melamine resin that has a weight average molecular weight of 400 to 900, contains crosslinkable functional groups composed of 5 to 20% of at least one member selected from alkoxy(C₃₋₈)methyl groups and 95 to 80% of at least one member selected from methylol groups and alkoxy(C₁₋₂)methyl groups, has a mononuclear melamine content of 40 to 70 wt. %, and has a water tolerance of 10 to 40. However, the coating film formed using the aqueous coating composition also has poor smoothness and may have metallic mottling.

Recently, in order to reduce the space required for the coating process and to decrease the energy cost, studies have been conducted on a coating method in which the baking and curing step after applying an intermediate coating composition is omitted, and after applying an overcoating composition over an uncured intermediate coating, the intermediate coating and overcoating are simultaneously baked and cured (e.g., Japanese Unexamined Patent Publication No. 2004-267834). However, in this coating method, the intermediate coating and overcoating are likely to mix with each other, and therefore the resulting coating film may be poor in smoothness and flip-flop effect, and may have metallic mottling.

### DISCLOSURE OF THE INVENTION

### Problems to be Solved by the Invention

An object of the present invention is to provide a colored coating composition that is capable of forming a multilayer coating film with excellent smoothness, and in particular, to provide a colored coating composition that is capable of forming a multilayer coating film having excellent appearance with a high flip-flop effect and little metallic mottling, when the second colored coating composition (Y) described below, which is an aqueous coating composition (hereinafter sometimes referred to briefly as “aqueous second colored coating composition (Y)”), contains a luster pigment.

### Means for Solving the Problems

The present inventors conducted extensive research to achieve the above object, and, as a result, found that a colored coating composition with a specific formulation can achieve the object, thereby accomplishing the present invention.

The present invention provides the following colored coating composition, method for forming a multilayer coating film using the composition, and article coated with the composition.

1. A colored coating composition comprising:

(A) a hydroxy-containing resin,
(B) a curing agent,
(C) a diester compound represented by Formula (1)

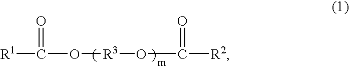

wherein R¹ and R² are each independently a C₄₋₁₈ hydrocarbon group, R³ is a C₂₋₄ alkylene group, m is an integer of 3 to 25, and m oxyalkylene units (R³—O) may be the same or different,
(D1) a coloring pigment, and
(D2) an extender pigment;

the total amount of the coloring pigment (D1) and the extender pigment (D2) being 40 to 180 parts by mass per 100 parts by mass of the hydroxy-containing resin (A) and the curing agent (B) in total.

2. A colored coating composition according to Item 1, wherein the hydroxy-containing resin (A) is at least one member selected from the group consisting of a hydroxy-containing polyester resin (A1) and a hydroxy-containing acrylic resin (A2).

3. A colored coating composition according to Item 2, wherein the hydroxy-containing polyester resin (A1) is a hydroxy-containing polyester resin obtained by reacting an acid component (a1-1) containing 30 mol % or more of an aliphatic polybasic acid (a1-1-1) and an alicyclic polybasic acid (a1-1-2) in total, with an alcohol component (a1-2).

4. A colored coating composition according to Item 1, wherein the diester compound (C) is a diester compound of a polyoxyalkylene glycol with an aliphatic monocarboxylic acid.

5. A colored coating composition according to Item 1, comprising 30 to 95 mass % of the hydroxy-containing resin (A) and 5 to 70 mass % of the curing agent (B), based on the total amount of the hydroxy-containing resin (A) and the curing agent (B).

6. A colored coating composition according to Item 1, comprising 1 to 30 parts by mass of the diester compound (C) per 100 parts by mass of the hydroxy-containing resin (A) and the curing agent (B) in total.

7. A colored coating composition according to Item 1, further comprising a urethane emulsion (F) that is substantially free of hydroxy groups.

8. A colored coating composition according to Item 7, comprising 1 to 80 parts by mass of the urethane emulsion (F) per 100 parts by mass of the hydroxy-containing resin (A) and the curing agent (B) in total.

9. A colored coating composition according to Item 1, which is an aqueous coating composition.

10. An article coated with a colored coating composition according to Item 1.

11. A method for forming a multilayer coating film, the method comprising:

(1) applying a colored coating composition according to Item 1 to a substrate to form a first colored coating;

(2) applying a second colored coating composition, which is an aqueous coating composition, to the uncured first colored coating to form a second colored coating; and

(3) heating the uncured first colored coating and the uncured second colored coating to cure both coatings simultaneously.

12. A method according to Item 11, wherein the second colored coating composition comprises a luster pigment (D3).

13. A method according to Item 11, wherein the substrate is a motor vehicle body having an undercoating film formed thereon using an electrodeposition coating composition.

14. An article coated by a method according to Item 11.

### Colored Coating Composition

The colored coating composition of the present invention (hereinafter sometimes referred to briefly as “first colored coating composition (X)”) comprises:

(A) a hydroxy-containing resin,
(B) a curing agent,
(C) a diester compound represented by Formula (1)

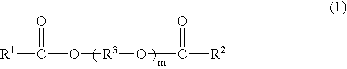

wherein R¹ and R² are each independently a C₄₋₁₈ hydrocarbon group, R³ is a C₂₋₄ alkylene group, m is an integer of 3 to 25, and m oxyalkylene units (R³—O) may be the same or different,
(D1) a coloring pigment, and
(D2) an extender pigment;
the total amount of the coloring pigment (D1) and the extender pigment (D2) being 40 to 180 parts by mass per 100 parts by mass of the hydroxy-containing resin (A) and the curing agent (B) in total.

In a multilayer coating film-forming method in which a first colored coating composition (X) is applied to a substrate to form a first colored coating, and an aqueous second colored coating composition (Y) is applied over the uncured first colored coating to form a second colored coating, the composition of the present invention can be advantageously used as the first colored coating composition (X).

### Hydroxy-Containing Resin (A)

The multilayer coating film is improved in water resistance and the like by containing the hydroxy-containing resin (A).

The hydroxy-containing resin (A) is a resin having at least one hydroxy group per molecule. From the viewpoint of the water resistance and other properties of the resulting coating film, the hydroxy-containing resin (A) preferably has a hydroxy value of about 1 to about 300 mg KOH/g, more preferably about 5 to about 250 mg KOH/g, and even more preferably about 10 to about 180 mg KOH/g.

The hydroxy-containing resin (A) may have acid groups in the molecule. Examples of acid groups include carboxy groups, sulfonic acid groups, phosphoric acid groups, etc. It is particularly preferable that the hydroxy-containing resin (A) have one or more carboxy groups as acid groups.

When the composition of the present invention is used as an aqueous coating composition, the hydroxy-containing resin (A) can be made water soluble or water dispersible by neutralizing the acid group(s), preferably carboxy group(s), with a basic compound.

Examples of the basic compound include sodium hydroxide, potassium hydroxide, lithium hydroxide, calcium hydroxide, barium hydroxide, and like hydroxides of alkali metals or alkaline earth metals; ammonia; ethylamine, propylamine, butylamine, benzylamine, monoethanolamine, neopentanolamine, 2-aminopropanol, 2-amino-2-methyl-1-propanol, 3-aminopropanol, and like primary monoamines; diethylamine, diethanolamine, di-n-propanolamine, di-iso-propanolamine, N-methylethanol amine, N-ethylethanolamine, and like secondary monoamines; dimethylethanolamine, trimethylamine, triethylamine, triisopropylamine, methyldiethanolamine, 2-(dimethylamino)ethanol, and like tertiary monoamines; diethylenetriamine, hydroxyethylaminoethylamine, ethylaminoethylamine, methylaminopropylamine, and like polyamines; etc.

The amount of the basic compound used is preferably about 0.1 to about 1.5 equivalents, and more preferably about 0.2 to about 1.2 equivalents, relative to the acid groups of the hydroxy-containing resin (A).

The term “aqueous coating composition” is used in contrast to “organic solvent-based coating composition”, and generally means a coating composition in which a coating film-forming resin, pigment, etc., are dispersed and/or dissolved in water or a medium mainly consisting of water (aqueous medium). To reduce environmental burdens, the composition of the present invention is preferably an aqueous coating composition. When the composition of the present invention is an aqueous coating composition, the composition preferably has a water content of about 10 to about 90 mass %, more preferably about 20 to about 80 mass %, and even more preferably about 30 to about 60 mass %.

From the viewpoint of the storage stability of the coating composition, the water resistance of the resulting coating film, etc., the hydroxy-containing resin (A) preferably has an acid value of about 1 to about 200 mg KOH/g, more preferably about 2 to about 100 mg KOH/g, and even more preferably about 3 to about 60 mg KOH/g. In particular, when a hydroxy-containing resin with an acid value of 10 mg KOH/g or less is used, instead of being neutralized with a basic compound, the hydroxy-containing resin (A) may be mixed with an emulsifier and agitated by applying a mechanical shear force to disperse the hydroxy-containing resin (A) in water forcibly, so that the composition of the present invention can be used as an aqueous coating composition.

Examples of the hydroxy-containing resin (A) include polyester resins, acrylic resins, polyether resins, polycarbonate resins, polyurethane resins, epoxy resins, alkyd resins, etc. These can be used singly or in combination of two or more. It is especially preferable that the hydroxy-containing resin (A) be at least one member selected from the group consisting of a hydroxy-containing polyester resin (A1) and a hydroxy-containing acrylic resin (A2), and it is more preferable that the hydroxy-containing resin (A) be a hydroxy-containing polyester resin (A1).

It is also possible to use, in combination with the resin (A1) or (A2), a so-called urethane-modified polyester resin or urethane-modified acrylic resin, which is obtained by a urethane reaction of a polyisocyanate compound with some of the hydroxy groups of the hydroxy-containing polyester resin (A1) or hydroxy-containing acrylic resin (A2) to extend the chain of the resin to increase the molecular weight.

The hydroxy-containing polyester resin (A1) can be produced by an esterification or transesterification reaction of an acid component (a1-1) with an alcohol component (a1-2).

A compound that is conventionally used as an acid component for producing a polyester resin can be used as the acid component (a1-1). Examples of the acid component (a1-1) include an aliphatic polybasic acid (a1-1-1), an alicyclic polybasic acid (a1-1-2), an aromatic polybasic acid (a1-1-3), etc.

The aliphatic polybasic acid (a1-1-1) is generally an aliphatic compound having two or more carboxy groups per molecule; an acid anhydride of the aliphatic compound; or an ester of the aliphatic compound. Examples of the aliphatic polybasic acid (a1-1-1) include succinic acid, glutaric acid, adipic acid, pimelic acid, suberic acid, azelaic acid, sebacic acid, undecanedioic acid, dodecanedioic acid, brassylic acid, octadecanedioic acid, citric acid, and like aliphatic polycarboxylic acids; anhydrides of these aliphatic polycarboxylic acids; lower alkyl esters of these aliphatic polycarboxylic acids, etc. Such examples of the aliphatic polybasic acid (a1-1-1) can be used singly or in combination of two or more.

From the viewpoint of chipping resistance, it is particularly preferable to use adipic acid and/or adipic anhydride as the aliphatic polybasic acid (a1-1-1).

The alicyclic polybasic acid (a1-1-2) is generally a compound having one or more alicyclic structures (mainly 4- to 6-membered-rings) and two or more carboxy groups per molecule; an acid anhydride of the compound; or an ester of the compound. Examples of the alicyclic polybasic acid (a1-1-2) include 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, 1,3,5-cyclohexanetricarboxylic acid, and like alicyclic polycarboxylic acids; anhydrides of these alicyclic polycarboxylic acids; lower alkyl esters of these alicyclic polycarboxylic acids; etc. Such examples of the alicyclic polybasic acid (a1-1-2) can be used singly or in combination of two or more.

From the viewpoint of the chipping resistance, it is particularly preferable to use, as the alicyclic polybasic acid (a1-1-2), 1,2-cyclohexanedicarboxylic acid, 1,3-cyclohexanedicarboxylic acid, 1,4-cyclohexanedicarboxylic acid, 4-cyclohexene-1,2-dicarboxylic acid, or 4-cyclohexene-1,2-dicarboxylic anhydride; and it is more preferable to use 1,2-cyclohexanedicarboxylic acid and/or 1,2-cyclohexanedicarboxylic anhydride.

The aromatic polybasic acid (a1-1-3) is generally an aromatic compound having two or more carboxy groups per molecule; an acid anhydride of the aromatic compound; or an ester of the aromatic compound. Examples of the aromatic polybasic acid (a1-1-3) include phthalic acid, isophthalic acid, terephthalic acid, naphthalenedicarboxylic acid, 4,4′-biphenyldicarboxylic acid, trimellitic acid, pyromellitic acid, and like aromatic polycarboxylic acids; anhydrides of these aromatic polycarboxylic acids; lower alkyl esters of these aromatic polycarboxylic acids; etc. Such examples of the aromatic polybasic acid (a1-1-3) can be used singly or in combination of two or more.

It is particularly preferable to use, as the aromatic polybasic acid (a1-1-3), phthalic acid, phthalic anhydride, isophthalic acid, trimellitic acid, or trimellitic anhydride.

Examples of the acid component (a1-1) other than the aliphatic polybasic acid (a1-1-1), alicyclic polybasic acid (a1-1-2), and aromatic polybasic acid (a1-1-3) include palm oil fatty acid, cotton seed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, safflower oil fatty acid, and like fatty acids; lauric acid, myristic acid, palmitic acid, stearic acid, oleic acid, linolic acid, linolenic acid, benzoic acid, p-tert-butyl benzoic acid, cyclohexane acid, 10-phenyloctadecanoic acid, and like monocarboxylic acids; lactic acid, 3-hydroxybutanoic acid, 3-hydroxy-4-ethoxybenzoic acid, and like hydroxycarboxylic acids; etc. Such examples of the acid component (a1-1) can be used singly or in combination of two or more.

A polyhydric alcohol having at least two hydroxy groups can be suitably used as the alcohol component (a1-2). Examples of such polyhydric alcohols include ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentylglycol, 1,4-cyclohexanedimethanol, tricyclodecanedimethanol, hydrogenated bisphenol A, hydrogenated bisphenol F, and like dihydric alcohols; polylactone diols obtained by adding lactones, such as ε-caprolactone or the like, to these dihydric alcohols; bis(hydroxyethyl)terephthalate and like ester diols; alkylene oxide adducts of bisphenol A, polyethylene glycol, polypropylene glycol, polybutylene glycol, and like polyether diols; glycerol, trimethylolethane, trimethylolpropane, diglycerol, triglycerol, 1,2,6-hexanetriol, pentaerythritol, dipentaerythritol, tris(2-hydroxyethyl)isocyanuric acid, sorbitol, mannite, and like trihydric or higher hydric alcohols; polylactone polyols obtained by adding lactones, such as ε-caprolactone, to these trihydric or higher hydric alcohols; etc.

Examples of the alcohol component (a1-2) other than the above polyhydric alcohols include methanol, ethanol, propyl alcohol, butyl alcohol, stearyl alcohol, 2-phenoxyethanol, and like monohydric alcohols; alcohol compounds obtained by reacting acids with monoepoxy compounds, such as propylene oxide, butylene oxide, a glycidyl ester of a synthetic highly branched saturated fatty acid (tradename “Cardula E10”, manufactured by HEXION Specialty Chemicals), etc.; and the like.

The method for producing the hydroxy-containing polyester resin (A1) is not limited, and may be a conventional method. For example, a method can be employed in which the acid component (a1-1) is reacted with the alcohol component (a1-2) in a nitrogen stream at 150 to 250° C. for 5 to 10 hours to perform an esterification or transesterification reaction.

In the esterification or transesterification reaction, the acid component (a1-1) and alcohol component (a1-2) can be added at once or in divided portions. A carboxy-containing polyester resin may be first synthesized and then esterified with the alcohol component (a1-2). Alternatively, the hydroxy-containing polyester resin (A1) may be first synthesized and then reacted with an acid anhydride to half-esterify the hydroxy-containing polyester resin.

In the esterification or transesterification reaction, a catalyst may be used to promote the reaction. Known catalysts are usable including dibutyltin oxide, antimony trioxide, zinc acetate, manganese acetate, cobalt acetate, calcium acetate, lead acetate, tetrabuthyl titanate, tetraisopropyl titanate, etc.

The hydroxy-containing polyester resin (A1) can be modified with a fatty acid, a monoepoxy compound, a polyisocyanate compound, or the like during the preparation of the resin or after the esterification or transesterification reaction.

Examples of the fatty acid include palm oil fatty acid, cotton seed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, safflower oil fatty acid, etc.

Preferable examples of the monoepoxy compound include a glycidyl ester of a synthetic highly branched saturated fatty acid (tradename “Cardura E10”, a product of HEXION Specialty Chemicals).

Examples of the polyisocyanate compound include lysine diisocyanate, hexamethylene diisocyanate, trimethylhexane diisocyanate, and like aliphatic diisocyanates; hydrogenated xylylene diisocyanate, isophorone diisocyanate, methylcyclohexane-2,4-diisocyanate, methylcyclohexane-2,6-diisocyanate, 4,4′-methylenebis(cyclohexylisocyanate), 1,3-(isocyanatomethyl)cyclohexane, and like alicyclic diisocyanates; tolylene diisocyanate, xylylene diisocyanate, diphenylmethane diisocyanate, and like aromatic diisocyanates; organic polyisocyanates themselves, such as lysine triisocyanate and like tri- or higher polyisocyanates, adducts of such organic polyisocyanates with polyhydric alcohols, low-molecular-weight polyester resins, water or the like, cyclopolymers (e.g., isocyanurates), biuret-type adducts, etc., of the organic diisocyanates. These can be used singly or in combination of two or more.

The hydroxy-containing polyester resin (A1) has a hydroxy value of preferably about 10 to about 300 mg KOH/g, more preferably about 50 to about 250 mg KOH/g, and even more preferably about 80 to about 180 mg KOH/g. The hydroxy-containing polyester resin (A1) has an acid value of preferably about 1 to about 200 mg KOH/g, more preferably about 15 to about 100 mg KOH/g, and even more preferably about 25 to about 60 mg KOH/g.

The hydroxy-containing polyester resin (A1) has a weight average molecular weight of preferably about 500 to about 50,000, more preferably about 1,000 to about 30,000, and even more preferably about 1,500 to about 20,000.

The number average molecular weight and weight average molecular weight as used herein are determined by converting the number average molecular weight and weight average molecular weight measured using a gel permeation chromatograph (tradename “HLC8120GPC”, a product of Tosoh Corporation), based on the molecular weight of polystyrene standards. The measurement was performed using four columns “TSKgel G-4000 HXL”, “TSKgel G-3000 HXL”, “TSKgel G-2500 HXL”, and “TSKgel G-2000 HXL” (tradenames, products of Tosoh Corporation) under the following conditions. Mobile phase: tetrahydrofuran; measurement temperature: 40° C.; flow rate: 1 ml/min.; and detector: RI.

When the composition of the present invention contains the hydroxy-containing polyester resin (A1) as the hydroxy-containing resin (A), the amount of the hydroxy-containing polyester resin (A1) in the composition is preferably about 5 to about 95 mass %, more preferably about 20 to about 80 mass %, and even more preferably about 30 to about 60 mass %, based on the total amount of the hydroxy-containing resin (A) and the curing agent (B) described hereinafter.

From the viewpoint of the smoothness and chipping resistance of the resulting coating film, it is preferable that the hydroxy-containing polyester resin (A1) be a hydroxy-containing polyester resin obtained by reacting the acid component (a1-1) containing 30 mol % or more of the aliphatic polybasic acid (a1-1-1) and the alicyclic polybasic acid (a1-1-2) in total, with the alcohol component (a1-2). It is especially preferable that the total amount of the aliphatic polybasic acid (a1-1-1) and alicyclic polybasic acid (a1-1-2) in the acid component (a1-1) be 40 to 97 mol %, and more preferably about 50 to about 80 mol %.

In particular, a hydroxy-containing polyester resin obtained by using adipic acid and/or adipic anhydride as the aliphatic polybasic acid (a1-1-1) and using 1,2-cyclohexanedicarboxylic acid and/or 1,2-cyclohexanedicarboxylic anhydride as the alicyclic polybasic acid (a1-1-2) is preferable from the viewpoint of the chipping resistance of the resulting coating film.

The hydroxy-containing acrylic resin (A2) can be produced by copolymerizing a hydroxy-containing polymerizable unsaturated monomer (a2-1) and another polymerizable unsaturated monomer (a2-2) that is copolymerizable with the hydroxy-containing polymerizable unsaturated monomer (a2-1) by, for example, a known method such as solution polymerization in an organic solvent, emulsion polymerization in water, etc.

The hydroxy-containing polymerizable unsaturated monomer (a2-1) is a compound having one or more hydroxy groups and one or more polymerizable unsaturated bonds per molecule. Examples of such monomers include monoesters of (meth)acrylates with C₂₋₈ dihydric alcohols, such as 2-hydroxyethyl (meth)acrylate, 2-hydroxypropyl (meth)acrylate, 3-hydroxypropyl (meth)acrylate, 4-hydroxybutyl (meth)acrylate, etc.; ε-caprolactone-modified products of these monoesters; N-hydroxymethyl (meth)acrylamide; allyl alcohols; (meth)acrylates having hydroxy-terminated polyoxyethylene chains; etc.

Examples of the other polymerizable unsaturated monomer (a2-2) that is polymerizable with the hydroxy-containing polymerizable unsaturated monomer (a2-1) include methyl (meth)acrylate, ethyl (meth)acrylate, n-propyl (meth)acrylate, i-propyl (meth)acrylate, n-butyl (meth)acrylate, i-butyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, “Isostearyl Acrylate” (tradename, a product of Osaka Organic Chemical Industry Ltd.), cyclohexyl (meth)acrylate, methylcyclohexyl (meth)acrylate, t-butylcyclohexyl (meth)acrylate, cyclododecyl (meth)acrylate, and like alkyl or cycloalkyl (meth)acrylates; isobornyl (meth)acrylate and like isobornyl group-containing polymerizable unsaturated monomers; adamanthyl (meth)acrylate, and like adamanthyl group-containing polymerizable unsaturated monomers; styrene, α-methylstyrene, vinyltoluene, and like vinyl aromatic compounds; vinyltrimethoxysilane, vinyltriethoxysilane, vinyltris (2-methoxyethoxy)silane, γ-(meth) acryloyloxypropyl trimethoxysilane, γ-(meth) acryloyloxypropyl triethoxysilane, and like alkoxysilyl group-containing polymerizable unsaturated monomers; perfluorobutylethyl (meth)acrylate, perfluorooctylethyl (meth)acrylate, and like perfluoroalkyl (meth)acrylates; fluoroolefins and like fluorinated alkyl group-containing polymerizable unsaturated monomers; polymerizable unsaturated monomers having photopolymerizable functional groups such as maleimide groups; N-vinylpyrrolidone, ethylene, butadiene, chloroprene, vinyl propionate, vinyl acetate, and like vinyl compounds; (meth)acrylic acid, maleic acid, crotonic acid, β-carboxyethyl acrylate, and like carboxy-containing polymerizable unsaturated monomers; (meth)acrylonitrile, (meth)acrylamide, N,N-dimethylaminoethyl (meth)acrylate, N,N-dimethylaminopropyl (meth)acrylamide, amine adducts of glycidyl (meth)acrylate, and like nitrogen-containing polymerizable unsaturated monomers; allyl (meth)acrylate, 1,6-hexanediol di(meth)acrylate, and like polymerizable unsaturated monomers having two or more polymerizable unsaturated groups per molecule; glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, allyl glycidyl ether, and like epoxy group-containing polymerizable unsaturated monomers; (meth)acrylates having alkoxy-terminated polyoxyethylene chains; 2-acrylamide-2-methylpropanesulfonic acid, allylsulfonic acid, styrenesulfonic acid, sulfoethyl methacrylate, and like sulfonic acid group-containing polymerizable unsaturated monomers; sodium salts and ammonium salts of these sulfonic acid group-containing polymerizable unsaturated monomers; 2-acryloyloxyethyl acid phosphate, 2-methacryloyloxyethyl acid phosphate, 2-acryloyloxypropyl acid phosphate, 2-methacryloyloxypropyl acid phosphate, and like phosphoric acid group-containing polymerizable unsaturated monomers; 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, 2-(2′-hydroxy-5′-methacryloyloxyethylphenyl)-2H-benzotriazole, and like polymerizable unsaturated monomers having UV-absorbing functional groups; 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoyloxyamino-2,2,6,6-tetramethylpiperidine, 1-crotonoyl-4-crotonoyloxy-2,2,6,6-tetramethylpiperidine, and like UV-stable polymerizable unsaturated monomers; acrolein, diacetone acrylamide, diacetone methacrylamide, acetoacetoxylethyl methacrylate, formylstyrol, vinyl alkyl ketones having 4 to 7 carbon atoms (e.g., vinyl methyl ketone, vinyl ethyl ketone, and vinyl butyl ketone), and like carbonyl group-containing polymerizable unsaturated monomers; polymerizable unsaturated monomers having cationic functional groups such as tertiary amino groups, quaternary ammonium salt groups; etc. Such examples of the polymerizable unsaturated monomer (a2-2) can be used singly or in combination of two or more.

The hydroxy-containing acrylic resin (A2) preferably has one or more amide groups.

A hydroxy-containing acrylic resin having one or more amide groups can be produced by, for example, using an amide group-containing polymerizable unsaturated monomer, such as (meth)acrylamide, N-methylol (meth)acrylamide, N,N-dimethylaminopropyl (meth)acrylamide, or the like, as at least a part of the above-mentioned polymerizable unsaturated monomer (a2-2).

The hydroxy-containing acrylic resin (A2) preferably has one or more cationic functional groups.

A hydroxy-containing acrylic resin having one or more cationic functional groups can be produced by, for example, using a polymerizable unsaturated monomer having one or more cationic functional groups such as tertiary amino groups, quaternary ammonium salt groups, or the like, as at least a part of the polymerizable unsaturated monomer (a2-2).

Examples of the tertiary amino group-containing polymerizable unsaturated monomer include N,N-dimethylaminoethyl (meth)acrylate, N,N-diethylaminoethyl (meth)acrylate, N,N-dimethylaminopropyl (meth)acrylate, N,N-di-t-butylaminoethyl (meth)acrylate, N,N-dimethylaminobutyl (meth)acrylate, and like N,N-dialkylaminoalkyl (meth)acrylates; N,N-dimethylaminoethyl (meth)acrylamide, N,N-diethylaminoethyl (meth)acrylamide, N,N-dimethylaminopropyl (meth)acrylamide, and like N,N-dialkylaminoalkyl (meth)acrylamides, etc. Among these, it is preferable to use at least one of N,N-dimethylaminoethyl (meth)acrylate and N,N-diethylaminoethyl (meth)acrylate.

Examples of the quaternary ammonium salt group-containing polymerizable unsaturated monomer include 2-(methacryloyloxy)ethyl trimethyl ammonium chloride, 2-(methacryloyloxy)ethyl trimethyl ammonium bromide, 2-(methacryloyloxy)ethyl trimethyl ammonium dimethyl phosphate, and like (meth)acryloyloxyalkyl trialkyl ammonium salts; methacryloyl aminopropyl trimethyl ammonium chloride, methacryloyl aminopropyl trimethyl ammonium bromide, and like (meth)acryloylaminoalkyl trialkylammonium salts; etc. Among these, it is preferable to use 2-(methacryloyloxy)ethyl trimethyl ammonium chloride.

From the viewpoint of the storage stability, the water resistance of the resulting coating film, etc., the hydroxy-containing acrylic resin (A2) has a hydroxy value of preferably about 1 to about 200 mg KOH/g, more preferably about 2 to about 100 mg KOH/g, and even more preferably about 3 to about 60 mg KOH/g.

When the hydroxy-containing acrylic resin (A2) has one or more acid groups, such as carboxy groups, the hydroxy-containing acrylic resin (A2) has an acid value of preferably about 1 to about 200 mg KOH/g, more preferably about 2 to about 150 mg KOH/g, and even more preferably about 5 to about 100 mg KOH/g, from the viewpoint of the water resistance and other properties of the resulting coating film.

It is suitable that the hydroxy-containing acrylic resin (A2) have a weight average molecular weight of preferably 1,000 to 200,000, more preferably 2,000 to 100,000, and even more preferably 3,000 to 50,000.

When the composition of the present invention comprises the hydroxy-containing acrylic resin (A2) as the hydroxy-containing resin (A), the amount of the hydroxy-containing acrylic resin (A2) in the composition is preferably about 5 to about 95 mass %, more preferably about 10 to about 70 mass %, and even more preferably about 20 to about 50 mass %, based on the total amount of the hydroxy-containing resin (A) and the curing agent (B) described below.

### Curing Agent (B)

The multilayer coating film is improved in water resistance and other properties by containing the curing agent (B).

Compounds that are reactive with hydroxy groups in the hydroxy-containing resin (A) can usually be used as the curing agent (B). For example, an amino resin (B1), a polyisocyanate compound (B2), and a blocked polyisocyanate compound (B3) are preferably usable.

When the composition of the present invention is used as an aqueous coating composition, it is preferable that the composition contain, as the curing agent (B), the amino resin (B1) and/or the blocked polyisocyanate compound (B3), and particularly preferably both the amino resin (B1) and the blocked polyisocyanate compound (B3).

When the composition of the present invention is used as a solvent-based coating composition, it is preferable that the composition contain, as the curing agent (B), the amino resin (B1) and/or the polyisocyanate compound (B2).

These compounds can be used singly or in combination of two or more, as the curing agent (B).

Examples of the amino resin (B1) include partially or fully methylolated amino resins obtained by reacting amino components with aldehyde components. Examples of the amino components include melamine, urea, benzoguanamine, acetoguanamine, steroguanamine, spiroguanamine, dicyandiamide, etc. Examples of the aldehyde components include formaldehyde, paraformaldehyde, acetaldehyde, benzaldehyde, etc.

Also usable are products obtained by partially or fully etherifying, with suitable alcohols, the methylol groups of the partially or fully methylolated amino resins. Examples of alcohols that can be for etherification include methyl alcohol, ethyl alcohol, n-propyl alcohol, i-propyl alcohol, n-butyl alcohol, i-butyl alcohol, 2-ethylbutanol, 2-ethylhexanol, etc.

The amino resin (B1) is preferably a melamine resin, and is particularly preferably methyl-etherified melamine resin (B1-1), which is obtained by partially or fully etherifying, with methyl alcohol, the methylol groups of a partially or fully methylolated melamine resin; butyl-etherified melamine resin (B1-2), which is obtained by partially or fully etherifying, with butyl alcohol, the methylol groups of a partially or fully methylolated melamine resin; methyl-butyl mixed etherified melamine resin (B1-3), which is obtained by partially or fully etherifying, with methyl alcohol and butyl alcohol, the methylol groups of a partially or fully methylolated melamine resin.

In particular, in order to obtain a multilayer coating film with excellent smoothness more easily, it is preferable that the composition of the present invention comprise, as the hydroxy-containing polyester resin (A1), a hydroxy-containing polyester resin in which the total amount of the aliphatic polybasic acid (a1-1-1) and the alicyclic polybasic acid (a1-1-2) in the acid component (a1-1) is 30 to 97 mol % and the amount of the aromatic polybasic acid (a1-1-3) in the acid component (a1-1) is 3 to 70 mol %; and, as the curing agent (B), at least one alkyl-etherified melamine resin selected from the methyl-etherified melamine resin (B1-1), the butyl-etherified melamine resin (B1-2), and the methyl-butyl mixed etherified melamine resin (B1-3).

From the viewpoint of the water resistance and chipping resistance of the resulting coating film, the melamine resin has a weight average molecular weight of preferably 400 to 5,000, more preferably 600 to 4,000, and even more preferably 1,000 to 3,000.

Commercial products of such melamine resins include, for example, “Cymel 202”, “Cymel 203”, “Cymel 238”, “Cymel 251”, “Cymel 303”, “Cymel 323”, “Cymel 324”, “Cymel 325”, “Cymel 327”, “Cymel 350”, “Cymel 385”, “Cymel 1156”, “Cymel 1158”, “Cymel 1116”, and “Cymel 1130” (products of Nihon Cytec Industries); U-Van 120”, “U-Van 20HS”, “U-Van 20SE60”, “U-Van 2021”, “U-Van 2028”, and “U-Van 28-60” (products of Mitsui Chemicals, Inc.); etc.

These melamine resins can be used singly or in combination of two or more.

When such a melamine resin is used as the curing agent (B), a curing catalysts can be used. Usable examples include paratoluene sulfonic acid, dodecylbenzenesulfonic acid, dinonylnaphthalene sulfonic acid, and like sulfonic acids; salts of these acids with amines; etc.

The polyisocyanate compound (B2) is usually a compound having two or more isocyanate groups per molecule. Such compounds include, for example, hexamethylene diisocyanate, trimethylhexamethylene diisocyanate, dimer acid diisocyanate, lysine diisocyanate, and like aliphatic polyisocyanates; biuret-type adducts and isocyanurate ring adducts of these polyisocyanates; isophorone diisocyanate, 4,4′-methylenebis(cyclohexyl isocyanate), methylcyclohexane-2,4-diisocyanate, methylcyclohexane-2,6-diisocyanate, 1,3-di(isocyanatomethyl)cyclohexane, 1,4-di(isocyanatomethyl)cyclohexane, 1,4-cyclohexanediisocyanate, 1,3-cyclopentanediisocyanate, 1,2-cyclohexanediisocyanate, and like alicyclic diisocyanates; biuret-type adducts and isocyanurate ring adducts of these alicyclic diisocyanates; xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenylether diisocyanate, m-phenylene diisocyanate, p-phenylene diisocyanate, 4,4′-biphenylene diisocyanate, 3,3′-dimethyl-4,4′-biphenylene diisocyanate, bis(4-isocyanatophenyl)sulfone, isopropylidenebis(4-phenylisocyanate), and like aromatic diisocyanate compounds; biuret-type adducts and isocyanurate ring adducts of these aromatic diisocyanates; triphenylmethane-4,4′,4″-triisocyanate, 1,3,5-triisocyanatobenzene, 2,4,6-triisocyanatotoluene, 4,4′-dimethyldiphenylmethane-2,2′,5,5′-tetraisocyanate, and like polyisocyanates having three or more isocyanate groups per molecule; biuret-type adducts and isocyanurate ring adducts of these polyisocyanates; urethane compounds obtained by reacting isocyanate groups of polyisocyanate compounds with hydroxy groups of polyols such as ethylene glycol, propylene glycol, 1,4-butylene glycol, dimethylolpropionic acid, polyalkylene glycol, trimethylolpropane, hexanetriol, etc., in a ratio such that the isocyanate groups are present in an excess amount; and biuret-type adducts, isocyanate ring adducts of these urethane compounds, etc.

The blocked polyisocyanate compound (B3) is usually obtained by adding a blocking agent to isocyanate groups of the polyisocyanate compound (B2). The blocked polyisocyanate compound (B3) reacts with hydroxy groups when the blocking agent is dissociated by heating to regenerate isocyanate groups. The dissociation temperature of the blocking agent is preferably about 60 to about 160° C., and more preferably about 70 to about 140° C.

Examples of the blocking agent include phenol, cresol, xylenol, nitrophenol, ethylphenol, hydroxydiphenyl, butylphenol, isopropylphenol, nonylphenol, octylphenol, hydroxymethyl benzoate, and like phenol compounds; ε-caprolactam, δ-valerolactam, γ-butyrolactam, β-propiolactam, and like lactam compounds; methanol, ethanol, propyl alcohol, butyl alcohol, amyl alcohol, lauryl alcohol, and like aliphatic alcohol compounds; ethylene glycol monomethyl ether, ethylene glycol monoethyl ether, ethylene glycol monobutyl ether, diethylene glycol monomethyl ether, diethylene glycol monoethyl ether, propylene glycol methyl ether, methoxy methanol, and like ether compounds; benzyl alcohol, glycolic acid, methyl glycolate, ethyl glycolate, butyl glycolate, lactic acid, methyl lactate, ethyl lactate, butyl lactate, methylolurea, methylolmelamine, diacetone alcohol, 2-hydroxyethyl acrylate, 2-hydroxyethyl methacrylate, and like alcohol compounds; formamidoxime, acetamidoxime, acetoxime, methylethylketoxime, diacetylmonoxime, benzophenonoxime, cyclohexanoxime, and like oxime compounds; dimethyl malonate, diethyl malonate, ethyl acetoacetate, methyl acetoacetate, acetylacetone, and like active methylene compounds; butyl mercaptan, t-butyl mercaptan, hexyl mercaptan, t-dodecyl mercaptan, 2-mercaptobenzothiazole, thiophenol, methylthiophenol, ethylthiophenol, and like mercaptan compounds; acetanilide, acetanisidide, acetotoluide, acrylamide, methacrylamide, acetamide, stearamide, benzamide, and like acid amide compounds; succinic acid imide, phthalic acid imide, maleic acid imide, and like imide compounds; diphenylamine, phenylnaphthylamine, xylidine, N-phenylxylidine, carbazole, aniline, naphthylamine, butylamine, dibutylamine, butylphenylamine, and like amine compounds; imidazole, 2-ethylimidazole, and like imidazole compounds; urea, thiourea, ethyleneurea, ethylenetiourea, diphenylurea, and like urea compounds; phenyl N-phenylcarbamate and like carbamic acid ester compounds; ethyleneimine, propyleneimine, and like imine compounds; sodium bisulfite, potassium bisulfite, and like sulfurous acid salts; pyrazole and pyrazole derivatives, such as 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, 3-methyl-5-phenylpyrazole, and the like; imidazole and imidazole derivatives such as imidazole, benzimidazole, 2-methylimidazole, 2-ethylimidazole, 2-phenylimidazole, and the like; azole compounds such as 2-methylimidazoline, 2-phenylimidazoline, like imidazoline derivatives, etc.; and hydroxycarboxylic acids having one or more hydroxy groups and one or more carboxy groups, such as hydroxypivalic acid, dimethylolpropionic acid, etc.; and the like.

Of these blocking agents, the oxime compounds, active methylene compounds, azole compounds (in particular, pyrazole and pyrazole derivatives), and hydroxycarboxylic acid are preferable.

In particular, when the composition of the present invention is used as an aqueous coating composition, a blocked polyisocyanate compound obtained by blocking isocyanate groups with a hydroxycarboxylic acid as mentioned above and neutralizing carboxy groups of the hydroxycarboxylic acid to impart water dispersibility, can be suitably used as the curing agent (B). Commercial products of such curing agents include, for example, “Bayhydur BL5140” manufactured by Sumika Bayer Urethane Co., Ltd.

The composition of the present invention contains the hydroxy-containing resin (A) in an amount of preferably about 30 to about 95 mass %, more preferably about 50 to about 90 mass %, and even more preferably about 60 to about 80 mass %; and the curing agent (B) in an amount of preferably about 5 to about 70 mass %, more preferably about 10 to about 50 mass %, and even more preferably about 20 to about 40 mass %; based on the total amount of the hydroxy-containing resin (A) and the curing agent (B).

It is preferable that the composition of the present invention contain, in addition to the hydroxy-containing resin (A), a resin for modification that is substantially free of hydroxy groups. Examples of the resin for modification include polyurethane resins, polyester resins, acrylic resins, alkyd resins, silicon resins, fluororesins, epoxy resins, etc.

Such examples of the resin for modification can be used singly or in combination of two or more. When the composition of the present invention contains such a resin for modification, the amount of the resin for modification is preferably not more than 80 parts by mass per 100 parts by mass of the hydroxy-containing resin (A) and the curing agent (B) in total.

From the viewpoint of the chipping resistance, water resistance, etc., of the resulting coating film, it is especially preferable that the composition contain a urethane emulsion (F) that is substantially free of hydroxy groups.

The urethane emulsion (F) is, for example, an emulsion prepared as follows: a urethane prepolymer is produced by reacting at least one diol selected from the group consisting of aliphatic and/or alicyclic diisocyanates, polyetherdiols, polyesterdiols, and polycarbonate diols, with a low-molecular-weight polyhydroxy compound and dimethanol alkanoic acid; the urethane prepolymer is neutralized with a tertiary amine and thereby emulsified and dispersed in water; and if necessary, the resulting emulsion is mixed with an aqueous medium containing a chain extender such as a polyamine or the like, a crosslinking agent, and/or a terminator, to perform a reaction until substantially no isocyanate group remains. The above method usually yields a self-emulsifiable urethane emulsion with a mean particle diameter of about 0.001 to about 3 μm. Examples of commercial products of the urethane emulsion (F) include “U-Coat UX-5000” and “U-Coat UX-8100” (tradenames, products of Sanyo Chemical Industries, Ltd.), etc.

When the composition of the present invention contains the urethane emulsion (F), the amount of the urethane emulsion (F) is preferably about 1 to about 80 parts by mass, more preferably about 5 to about 60 parts by mass, and even more preferably about 10 to about 40 parts by mass, per 100 parts by mass of the hydroxy-containing resin (A) and the curing agent (B) in total.

When the hydroxy-containing resin (A) and/or the resin for modification in the composition of the present invention have one or more crosslinkable functional groups, such as carboxy groups, epoxy groups, etc., a curing agent having one or more crosslinkable functional groups that are reactive with the above-mentioned crosslinkable functional groups can be used as the curing agent (B).

Examples of such curing agents include epoxy group-containing compounds, carboxy-containing compounds, carbodiimide group-containing compounds, all of which are reactive with the above crosslinkable functional groups. Among these, carbodiimide group-containing compounds are preferable.

Examples of carbodiimide group-containing compounds include compounds obtained by subjecting isocyanate groups of the polyisocyanate compound (B2) to a carbon dioxide removal reaction with each other. Examples of commercial products of such carbodiimide group-containing compounds include “Carbodilite V-02”, “Carbodilite V-02-L2”, “Carbodilite V-04”, “Carbodilite E-01”, and “Carbodilite E-02” (products of Nisshinbo Industries, Inc., tradenames), etc.

### Diester Compound (C)

The diester compound (C) is represented by Formula (1)

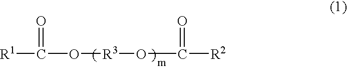

wherein R¹ and R² are each independently a C₄₋₁₈ hydrocarbon group, R³ is a C₂₋₄ alkylene group, m is an integer of 3 to 25, and m oxyalkylene units (R³—O) may be the same or different.

From the viewpoint of the smoothness, water resistance, flip-flop effect, and suppression of metallic mottling, of the resulting coating film, the carbon numbers of R¹ and R² in Formula (I) are preferably 4 to 18, more preferably 5 to 11, even more preferably 5 to 9, and still more preferably 6 to 8. R¹ and R² are preferably straight- or branched-chain alkyl groups, and more preferably branched-chain alkyl groups. It is particularly preferable that R¹ and R² be C₆₋₈ branched-chain alkyl groups. When R¹ and R² are branched-chain alkyl groups, the composition of the present invention is capable of forming a multilayer coating film having excellent appearance in which the smoothness and flip-flop effect are excellent and metallic mottling is suppressed, even if the composition is applied after relatively long-term storage.

The diester compound (C) has a molecular weight of preferably about 320 to about 1,400, more preferably about 450 to about 1,000, even more preferably about 500 to about 800, and still more preferably about 500 to about 700.

The diester compound (C) is preferably a diester compound of a polyoxyalkylene glycol with an aliphatic monocarboxylic acid. Specifically, the diester compound (C) can be obtained by, for example, an esterification reaction of a polyoxyalkylene glycol having two terminal hydroxy groups with a monocarboxylic acid having a C₄₋₁₈ hydrocarbon group.

Examples of the polyoxyalkylene glycol include polyethylene glycol, polypropylene glycol, copolymers of polyethylene and propylene glycol, polybutylene glycol, etc. Among these, it is particularly preferable to use polyethylene glycol.

The polyoxyalkylene glycol has a number average molecular weight of preferably about 100 to about 1,200, more preferably about 150 to about 600, and even more preferably about 200 to about 400.

Examples of the monocarboxylic acid having a C₄₋₁₈ hydrocarbon group include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid, octadecanoic acid, etc.

Among these, monocarboxylic acids having C₅₋₉ alkyl groups, such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, etc., are preferable; monocarboxylic acids having C₆₋₈ alkyl groups, such as heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, etc., are more preferable; and monocarboxylic acid having C₆₋₈ branched-chain alkyl groups, such as 2-ethylpentanoic acid, 3-ethylpentanoic acid, 2-ethylhexanoic acid, 4-ethylhexanoic acid, 2-ethylheptanoic acid, etc., are still more preferable.

These polyoxyalkylene glycols and monocarboxylic acids can be used singly or in combination of two or more.

The diesterification reaction of the polyoxyalkylene glycol with the monocarboxylic acid having a C₄₋₁₈ hydrocarbon group can be carried out by a known method.

The composition of the present invention preferably contains the diester compound (C) in an amount of about 1 to about 30 parts by mass, more preferably about 3 to about 20 parts by mass, and even more preferably about 5 to about 15 parts by mass, per 100 parts by mass of the hydroxy-containing resin (A) and the curing agent (B) in total.

Although it is not clear why a multilayer coating film with excellent smoothness can be formed by using the composition of the present invention as the first colored coating composition (X), it is presumed that a first colored coating with appropriate hydrophilicity is formed by applying the composition of the present invention, which contains the diester compound (C), and the aqueous second colored coating composition (Y) applied on the first colored coating uniformly wets and spreads over the first colored coating, thereby forming a multilayer coating film with excellent smoothness.

### Coloring Pigment (D1) and Extender Pigment (D2)

The composition of the present invention contains a coloring pigment (D1) and an extender pigment (D2) in a total amount of about 40 to about 180 parts by mass, preferably about 60 to about 160 parts by mass, and more preferably about 80 to about 140 parts by mass, per 100 parts by mass of the hydroxy-containing resin (A) and the curing agent (B) in total.

Examples of the coloring pigment (D1) include titanium oxide, zinc white, carbon black, molybdenum red, Prussian blue, cobalt blue, azo pigments, phthalocyanine pigments, quinacridone pigments, isoindoline pigments, indanthrene pigments, perylene pigments, etc. These can be used singly or in combination of two or more. It is particularly preferable to use titanium oxide and/or carbon black as the coloring pigment (D1).

The amount of the coloring pigment (D1) in the composition of the present invention is preferably about 1 to about 180 parts by mass, more preferably about 5 to about 160 parts by mass, and even more preferably about 10 to about 140 parts by mass, per 100 parts by mass of the hydroxy-containing resin (A) and curing agent (B) in total.

Examples of the extender pigment (D2) include clay, kaolin, barium sulfate, barium carbonate, calcium carbonate, talc, silica, alumina white, etc. These can be used singly or in combination of two or more. Barium sulfate and/or talc, and in particular barium sulfate, is preferably used as the extender pigment (D2).

The barium sulfate has a mean primary particle diameter of preferably 1 μm or less, and more preferably 0.01 to 0.8 μm. The composition of the present invention can advantageously form a multilayer coating film that has excellent appearance with excellent smoothness, an high flip-flop effect, and little metallic mottling by containing barium sulfate having a mean primary particle diameter of 1 μm or less as the extender pigment (D2).

The mean primary particle diameter of barium sulfate as used herein is determined by observing barium sulfate using a scanning electron microscope and averaging the maximum diameters of 20 barium sulfate particles on a straight line drawn at random on the electron microscope photograph.

The composition of the present invention contains the extender pigment (D2) in an amount of preferably about 1 to about 150 parts by mass, more preferably about 5 to about 130 parts by mass, and even more preferably about 10 to about 110 parts by mass, per 100 parts by mass of the hydroxy-containing resin (A) and curing agent (B) in total.

The composition of the present invention may contain, if necessary, one or more pigments other than the coloring pigment (D1) and the extender pigment (D2). Pigments other than the coloring pigment (D1) and the extender pigment (D2) include, for example, a luster pigment (D3).

The luster pigment (D3) imparts brilliant luster and pearlescent light interference patterns to a coating film. Specific examples of the luster pigment (D3) include aluminium (which may be vapor-deposited aluminum), copper, zinc, brass, nickel, aluminium oxide, mica, titanium oxide-coated or iron oxide-coated aluminium oxide, titanium oxide-coated or iron oxide-coated mica, etc.

The luster pigment (D3) is preferably in the form of flakes. Specifically, the luster pigment (D3) is preferably a flaky pigment having a longitudinal dimension of about 1 to about 100 μm, and preferably about 5 to about 40 μm, and a thickness of about 0.0001 to about 5 μm, and preferably about 0.001 to about 2 μm.

When the composition of the present invention contains pigment(s) other than the coloring pigment (D1) and the extender pigment (D2), such as the luster pigment (D3) or the like, the total amount of pigment other than the coloring pigment (D1) and the extender pigment (D2), contained in the composition of the present invention, is preferably about 1 to about 100 parts by mass, more preferably about 2 to about 60 parts by mass, and even more preferably about 3 to about 40 parts by mass, per 100 parts by mass of the hydroxy-containing resin (A) and curing agent (B) in total.

### Hydrophobic Solvent (E)

It is preferable that the composition of the present invention further contain a hydrophobic solvent (E). The hydrophobic solvent (E) is an organic solvent having a solubility such that its mass that dissolves at 20° C. in 100 g of water is 10 g or less, preferably 5 g or less, and more preferably 1 g or less. Examples of such organic solvents include rubber solvents, mineral spirits, toluol, xylol, solvent naphtha, and like hydrocarbon solvents; 1-hexanol, 1-octanol, 2-octanol, 2-ethylhexanol, 1-decanol, benzyl alcohol, ethylene glycol mono-2-ethylhexyl ether, propylene glycol mono-n-butyl ether, dipropylene glycol mono-n-butyl ether, tripropylene glycol mono-n-butyl ether, propylene glycol mono-2-ethylhexyl ether, propylene glycol monophenyl ether, and like alcohol solvents; n-butyl acetate, isobutyl acetate, isoamyl acetate, methylamyl acetate, ethylene glycol monobutyl ether acetate, and like ester solvents; and methyl isobutyl ketone, cyclohexanone, ethyl n-amyl ketone, diisobutyl ketone, and like ketone solvents. These can be used singly or in combination of two or more. From the viewpoint of the smoothness of the resulting multilayer coating film, it is preferable to use an alcohol solvent as the hydrophobic solvent (E). Among the above alcohol solvents, particularly preferable examples include C₇₋₁₄ alcohol solvents such as 1-octanol, 2-octanol, 2-ethyl-1-hexanol, ethylene glycol mono-2-ethylhexyl ether, propylene glycol mono-n-butyl ether, dipropylene glycol mono-n-butyl ether, etc.

When the composition of the present invention contains the hydrophobic solvent (E), the amount of the hydrophobic solvent (E) is preferably about 2 to about 60 parts by mass, more preferably about 5 to about 40 parts by mass, and even more preferably about 10 to about 30 parts by mass, per 100 parts by mass of the hydroxy-containing resin (A) and curing agent (B) in total.

### Other Additives

It is preferable that the composition of the present invention contain a thickener. Examples of the thickener include silicate, metal silicate, montmorillonite, organic montmorillonite, colloidal alumina, and like inorganic thickeners; copolymers of polyacrylic acid and (meth)acrylic acid esters, sodium polyacrylate and like polyacrylic acid thickeners; association thickeners having a hydrophilic moiety and hydrophobic moiety in a molecule, in which the hydrophobic moieties adsorb to the surfaces of the pigment or emulsion particles and the hydrophobic moieties are associated with each other, to thereby effectively exhibit thickening effects; carboxymethylcellulose, methylcellulose, hydroxyethylcellulose, and like cellulose derivative thickeners; casein, sodium caseinate, ammonium caseinate, and like protein thickeners; sodium alginate and like alginic acid thickeners; polyvinyl alcohol, polyvinyl pyrrolidone, polyvinyl benzyl ether copolymers, and like polyvinyl thickeners; polyether dialkyl ester, polyether dialkyl ether, polyether epoxy-modified products, and like polyether thickeners; partial esters of vinyl methyl ether-maleic anhydride copolymers, and like maleic anhydride copolymer thickeners; polyamide amine salts and like polyamide thickeners; etc. These thickeners can be used singly or in combination of two or more.

Examples of commercial products of the polyacrylic acid thickeners include “Primal ASE-60”, “Primal TT-615”, and “Primal RM-5” (tradenames of Rohm and Haas Co.); “SN Thickener 613”, “SN Thickener 618”, “SN Thickener 630”, “SN Thickener 634”, and “SN Thickener 636” (tradenames of San Nopco Ltd.); etc.

Examples of commercial products of association thickeners include “UH-420”, “UH-450”, “UH-462”, “UH-472”, “UH-540”, “UH-752”, “UH-756VF”, and “UH-814N” (tradenames of ADEKA Corp.); “Primal RM-8W”, “Primal RM-825”, “Primal RM-2020NPR”, “Primal RM-12W”, and “Primal SCT-275” (tradenames of Rohm and Haas Co.); “SN Thickener 612”, “SN Thickener 621N”, “SN Thickener 625N”, “SN Thickener 627N”, and “SN thickener 660T” (tradenames of San Nopco Ltd.), etc.

In the present invention, it is particularly preferable to use a polyacrylic acid thickener and/or association thickener as mentioned above, more preferably an association thickener, and even more preferably a urethane association thickener having a hydrophobic group at one or both ends and one or more urethane bonds in the molecular chain. Examples of commercial products of the urethane association thickener include the above-mentioned “UH-420”, “UH-462”, “UH-472”, “UH-540”, “UH-756VF”, “UH-814N”, “SN Thickener 612”, “SN Thickener 621N”, “SN Thickener 625N”, “SN Thickener 627N”, “SN Thickener 660T”, etc.

When the composition of the present invention contains such a thickener, the amount of the thickener in the composition of the present invention is preferably about 0.01 to about 10 parts by mass, more preferably about 0.05 to about 3 parts by mass, and even more preferably about 0.1 to about 2 parts by mass, per 100 parts by mass of the hydroxy-containing resin (A) and curing agent (B) in total. When the composition contains an association thickener as mentioned above, the amount of the association thickener in the composition is preferably about 0.01 to about 10 parts by mass, more preferably about 0.05 to about 2 parts by mass, and even more preferably about 0.1 to about 1 part by mass, per 100 parts by mass of the hydroxy-containing resin (A) and curing agent (B) in total.

The composition of the present invention may further contain, if necessary, conventional paint additives such as curing catalysts, UV absorbers, light stabilizers, antifoaming agents, plasticizers, organic solvents other than the hydrophobic solvent (E), surface control agents, antisettling agents, etc., singly or in combination of two or more.

The use of the composition of the present invention makes it possible to form a multilayer coating film with excellent smoothness. In particular, when a coating composition containing the luster pigment (D3) is used as the aqueous second colored coating composition (Y), a multilayer coating film can be formed which has excellent appearance with a high flip-flop effect and little metallic mottling. Therefore, the composition of the present invention can be suitably used especially as a coating composition for motor vehicles.

### Aqueous Second Colored Coating Composition (Y)

The aqueous second colored coating composition (Y) is generally intended to impart excellent appearance to a substrate. For example, a known coating composition that is conventionally used for coating motor vehicle bodies can be used as the aqueous second colored coating composition (Y). Specific examples include a coating composition obtained by dissolving or dispersing, in water, a resin component comprising a base resin and a curing agent, together with pigments and other additives. Examples of the base resin include acrylic resins, polyester resins, alkyd resins, urethane resins, epoxy resins, etc., all containing crosslinkable functional groups such as carboxy, hydroxy, etc. Examples of the curing agent include blocked or unblocked polyisocyanate compounds, melamine resins, urea resins, etc. In particular, a thermosetting aqueous coating composition containing the hydroxy-containing resin (A) and a melamine resin can be advantageously used.

The coloring pigment (D1), extender pigment (D2), luster pigment (D3), etc., can be used as the above-mentioned pigment. It is particularly preferable that the second colored coating composition (Y) contain the luster pigment (D3). The composition can form a multilayer coating film having excellent appearance with excellent smoothness, a high flip-flop effect, and little metallic mottling, by containing the luster pigment (D3).

Examples of the luster pigment (D3) include aluminium (which may be vapor-deposited aluminum), copper, zinc, brass, nickel, aluminium oxide, mica, titanium oxide-coated or iron oxide-coated aluminium oxide, titanium oxide-coated or iron oxide-coated mica, etc., as mentioned in the description of the first colored coating composition (X). Among these, aluminium, aluminium oxide, mica, titanium oxide- or iron oxide-coated aluminium oxide, and titanium oxide-coated or iron oxide-coated mica are particularly preferable, and aluminum is more particularly preferable. Such examples of the luster pigment (D3) can be used singly or in combination of two or more.

The luster pigment (D3) is preferably in the form of flakes. More specifically, the luster pigment (D3) is preferably a flaky pigment having a longitudinal dimension of about 1 to about 100 μm, and preferably about 5 to about 40 μm, and a thickness of about 0.0001 to about 5 μm, and preferably about 0.001 to about 2 μm.

By applying the aqueous second colored coating composition (Y) containing the luster pigment (D3) over a first colored coating obtained using the colored coating composition (first colored coating composition (X)) of the present invention, it is possible to form a multilayer coating film having excellent appearance with excellent smoothness, a high flip-flop effect, and little metallic mottling. Although the reason is not clear, it is presumed that, by using the colored coating composition containing the diester compound (C), a first colored coating with appropriate hydrophilicity is formed, and the aqueous second colored coating composition (Y) applied on the first colored coating uniformly wets and spreads over the first colored coating, so that the luster pigment (D3) in the aqueous second colored coating composition (Y) is present in the second colored coating in a relatively uniform state and is likely to be oriented parallel to the substrate, thereby forming a coating film having excellent appearance with a high flip-flop effect and little metallic mottling.

It is preferable that the aqueous second colored coating composition (Y) further contain the hydrophobic solvent (E).

From the viewpoint of the smoothness of the resulting multilayer coating film, it is preferable to use an alcohol solvent as the hydrophobic solvent (E). In particular, C₇₋₁₄ alcohol solvents are preferable, including, for example, 1-octanol, 2-octanol, 2-ethyl-1-hexanol, ethylene glycol mono-2-ethylhexyl ether, propylene glycol mono-n-butyl ether, dipropylene glycol mono-n-butyl ether, etc.

When the aqueous second colored coating composition (Y) contains the hydrophobic solvent (E), the amount of the hydrophobic solvent (E) is preferably about 2 to about 70 parts by mass, more preferably about 11 to about 60 parts by mass, and even more preferably about 16 to about 50 parts by mass, per 100 parts by mass of the total of the base resin and the curing agent in the aqueous second colored coating composition (Y).

The aqueous second colored coating composition (Y) may further contain, if necessary, conventional paint additives, such as curing catalysts, thickeners, UV absorbers, light stabilizers, antifoaming agents, plasticizers, organic solvents other than the hydrophobic solvent (E), surface control agents, antisettling agents, etc., singly or in combination of two or more.

### Method for Forming Multilayer Coating Film

The multilayer coating film-forming method of the present invention comprises the steps of:

(1) applying the colored coating composition to a substrate to form a first colored coating;
(2) applying a second colored coating composition, which is an aqueous coating composition, over the uncured first colored coating to form a second colored coating; and
(3) heating the uncured first colored coating and the uncured second colored coating to simultaneously cure both coatings.

In the multilayer coating film-forming method comprising applying a first colored coating composition (X) to a substrate to form a first colored coating, and applying an aqueous second coating composition (Y) over the uncured first colored coating to form a second colored coating, the composition of the present invention can be advantageously used as the first colored coating composition (X).

### Step (1)

In Step (1), the colored coating composition is applied to a substrate to form an uncured first colored coating.

The substrate is not limited, and examples include outer panels of motor vehicles such as automobiles, trucks, motorcycles, buses, etc.; parts of motor vehicles; outer panels of cellular phones, household electrical appliances such as audio equipment, etc; and the like. Among these, outer plates of motor vehicle bodies, and parts of motor vehicles, are preferable.

The material of the substrate is also not limited, and examples include iron, aluminium, brass, copper, stainless steel, tin, galvanized steel, alloyed zinc (Zn—Al, Zn—Ni, Zn—Fe, etc.), plated steel, and like metal materials; resins such as polyethylene resins, polypropylene resins, acrylonitrile-butadiene-styrene (ABS) resins, polyamide resins, acrylic resins, vinylidene chloride resins, polycarbonate resins, polyurethane resins, epoxy resins, etc., various FRPs, and like plastic materials; glass, cement, concrete, and like inorganic materials; wood; paper, cloth, and like fiber materials; etc. Among these, metal materials and plastic materials are preferable.

The substrate may be a metal material as mentioned above or a motor vehicle body formed from such a metal material, whose metal surface has been subjected to a surface treatment such as phosphate treatment, chromate treatment, compound oxide treatment, or the like. The substrate may also be a metal material, motor vehicle body, or the like as mentioned above on which an undercoating film and/or an intermediate coating film have been formed. In particular, a motor vehicle body on which an undercoating coating film has been formed using an electrodeposition coating composition is preferable, and a motor vehicle body on which an undercoating film has been formed using a cationic electrodeposition coating composition is more preferable.

The composition of the present invention may be applied to a substrate obtained by uniting a plastic member such as a bumper, with a metal member on which an undercoating film of any of various electrodeposition coating compositions has been formed as required. In this case, there are advantages in that the metal member and plastic member can be coated with the same color, and a multilayer coating film with excellent smoothness can be formed over both members.

The colored coating composition can be applied to the substrate by a known method. For example, the composition can be applied using an air spray, an airless spray, a rotary atomization coating device, or the like. An electrostatic charge may be applied during coating. In particular, electrostatic coating using an air spray and electrostatic coating using a rotary atomization coating device are preferable, and electrostatic coating using a rotary atomization coating device is more preferable.

After application of the colored coating composition, the obtained uncured first colored coating may be dried as required, by heating, air blowing, or like means, to an extent that the coating is not substantially cured, or the solids content of the uncured first colored coating may be adjusted to an extent that the coating does not dry. The heating can be performed by known heating means, using, for example, a drying oven such as a hot air oven, electric oven, infrared ray-induced heating oven, or the like.

When the uncured first colored coating is dried to an extent that the coating is not substantially cured, the drying (heating) temperature is preferably about 30 to about 100° C., more preferably about 40 to about 90° C., and even more preferably about 60 to about 80° C.

The drying (heating) time is not limited, but is preferably about 30 seconds to about 15 minutes, more preferably about 1 to about 10 minutes, and even more preferably about 2 to about 5 minutes.

The first colored coating is formed so as to obtain a cured film with a thickness of usually about 10 to about 100 μm, preferably about 10 to about 50 μm, and more preferably about 15 to about 35 μm.

### Step (2)

In Step (2), an aqueous second colored coating composition (Y) is applied over the uncured first colored coating to form an uncured second colored coating.

The uncured first colored coating may be a coating dried to a set-to-touch condition or a coating dried to a dry to touch condition.

The aqueous second colored coating composition (Y) can be applied by a known method. For example, the composition can be applied using an air spray, an airless spray, a rotary atomization coating device, or the like. An electrostatic charge may be applied during coating.

After application of the aqueous second colored coating composition (Y), it is preferable to perform, prior to Step (3) described hereinafter, preheating under conditions such that the uncured second colored coating is not substantially cured. Preheating can advantageously prevent coating film defects such as foaming. The preheating temperature is preferably about room temperature to about 100° C., more preferably about 40 to about 90° C., and even more preferably about 60 to about 80° C. The preheating temperature is preferably about 30 seconds to about 15 minutes, more preferably about 1 to about 10 minutes, and even more preferably about 2 to about 5 minutes.

The second colored coating is formed so as to obtain a cured film with a thickness of usually about 5 to about 60 μm, preferably about 10 to about 50 μm, and more preferably about 12 to about 30 μm.

### Step (3)

In Step (3), the uncured first colored coating and the uncured second colored coating are heated to simultaneously cure both coatings.

Heating can be performed by any of the above-mentioned known heating means.

The heating temperature is preferably about 80 to about 180° C., and more preferably about 100 to about 160° C.

The heating time is preferably about 10 to about 40 minutes, and more preferably about 15 to about 30 minutes.

In the method of the present invention, if necessary, a known clear coating composition may be applied over the second colored coating. When such a clear coating composition is applied, the uncured first colored coating, second colored coating, and clear coating may be simultaneously cured after application of the clear coating composition over the uncured second colored coating. Alternatively, the clear coating composition is applied over the cured second colored coating, and then cured.

### EFFECTS OF THE INVENTION

In the multilayer coating film-forming method comprising applying a first colored coating composition (X) to a substrate to form a first colored coating, and applying an aqueous second colored coating composition (Y) over the uncured first colored coating to form a second colored coating, the use of the colored coating composition of the present invention makes it possible to form a multilayer coating film with excellent smoothness.

In particular, when the aqueous second colored coating composition (Y) contains a luster pigment, it is possible to form a multilayer coating film having excellent appearance with a high flip-flop effect and little metallic mottling.

### BEST MODE FOR CARRYING OUT THE INVENTION

The present invention is described below in more detail with reference to Production Examples, Examples, and Comparative Examples. However, the present invention is not limited to these examples. In the examples, “parts” and “percentages” are expressed on a weight basis.

### Production of Hydroxy-Containing Polyester Resin (A)

### Production Example 1

A 174 part quantity of trimethylolpropane, 327 parts of neopentylglycol, 352 parts of adipic acid, 109 parts of isophthalic acid and 101 parts of 1,2-cyclohexanedicarboxylic acid anhydride were placed into a reaction vessel equipped with a thermometer, a thermostat, a stirrer, a reflux condenser and a water separator, and heated from 160° C. to 230° C. over 3 hours. The reaction was maintained at 230° C. while removing the condensation water using a water separator, and was allowed to proceed until the acid value became 3 mg KOH/g or less. Fifty-nine parts of trimellitic anhydride was added to the reaction product, and an addition reaction was performed at 170° C. for 30 minutes. Subsequently, the resultant adduct was cooled to 50° C. or less, and neutralized by adding an equal molar amount of 2-(dimethylamino) ethanol to the acid group derived from the trimellitic anhydride of the adduct. By gradually adding deionized water, a hydroxy-containing polyester resin solution (A1-1) with a solids content of 45% and a pH of 7.2 was obtained. The resulting hydroxy-containing polyester resin had an acid value of 35 mg KOH/g, a hydroxy value of 128 mg KOH/g, and a weight average molecular weight of 13,000.

The acid component reacted to synthesize the hydroxy-containing polyester resin had a total content of aliphatic polybasic acid and alicyclic polybasic acid of 76 mol %, and a content of aromatic polybasic acid of 24 mol %

### Production Example 2

A 168 part quantity of trimethylolpropane, 316 parts of neopentylglycol, 93 parts of adipic acid, 211 part of isophthalic acid, 188 parts of phthalic anhydride and 65 parts of 1,2-cyclohexanedicarboxylic acid anhydride were placed into a reaction vessel equipped with a thermometer, a thermostat, a stirrer, a reflux condenser and a water separator, and heated from 160° C. to 230° C. over 3 hours. The reaction was maintained at 230° C. while removing the water resulting from the condensation reaction using a water separator, and the reaction was allowed to proceed until the acid value became 3 mg KOH/g or less. Fifty-nine parts of trimellitic anhydride was added to the reaction product, and an addition reaction was performed at 170° C. for 30 minutes. Subsequently, the resultant adduct was cooled to 50° C. or less, and neutralized by adding an equivalent amount of 2-(dimethylamino)ethanol to the acid group derived from the trimellitic anhydride of the adduct. By gradually adding deionized water, a hydroxy-containing polyester resin solution (A1-2) with a solids content of 45% and a pH of 7.2 was obtained. The resulting hydroxy-containing polyester resin had an acid value of 35 mg KOH/g, a hydroxy value of 124 mg KOH/g, and a weight average molecular weight of 13,500.

The acid component reacted to synthesize the hydroxy-containing polyester resin had a total content of aliphatic polybasic acid and alicyclic polybasic acid of 27 mol %, and a content of aromatic polybasic acid of 73 mol %.

### Production Example 3

A 166 part quantity of trimethylolpropane, 314 parts of neopentylglycol, 338 parts of adipic acid and 194 parts of 1,2-cyclohexanedicarboxylic acid anhydride were placed into a reaction vessel equipped with a thermometer, a thermostat, a stirrer, a reflux condenser and a water separator, and heated from 160° C. to 230° C. over 3 hours. The reaction was maintained at 230° C. while removing the water resulting from the condensation reaction using a water separator, and allowed to proceed until the acid value became 3 mg KOH/g or less. Ninety-four parts of 1,2-cyclohexanedicarboxylic acid anhydride was added to the reaction product, and an addition reaction was performed at 170° C. for 30 minutes. Subsequently, the resultant adduct was cooled to 50° C. or less, and neutralized by adding an equivalent amount of 2-(dimethylamino)ethanol to the acid group derived from the 1,2-cyclohexanedicarboxylic acid anhydride of the adduct. By gradually adding deionized water, a hydroxy-containing polyester resin solution (A1-3) with a solids content of 45%, and pH of 7.2 was obtained. The resulting hydroxy-containing polyester resin had an acid value of 35 mg KOH/g, a hydroxy value of 106 mg KOH/g, and a weight average molecular weight of 12,700.

The acid component reacted to synthesize the hydroxy-containing polyester resin had a total content of aliphatic polybasic acid and alicyclic polybasic acid of 100 mol %, and a content of aromatic polybasic acid of 0 mol %.

### Production of Hydroxy-Containing Acrylic Resin (A2)

### Production Example 4

A 30 part quantity of propylene glycol monopropyl ether were placed into a reaction vessel equipped with a thermometer, a thermostat, a stirrer, a reflux condenser, a nitrogen inlet tube and a dropping funnel, and heated to 85° C. A mixture of 10 parts of styrene, 30 parts of methyl methacrylate, 15 parts of 2-ethylhexyl acrylate, 11.5 parts of n-butyl acrylate, 30 parts of 2-hydroxyethyl acrylate, 3.5 parts of acrylic acid, 10 parts of propylene glycol monopropyl ether and 4 parts of t-butyl-2-ethylhexanoate was added dropwise into a flask over 4 hours, and then aged for 1 hour. A mixture of 5 parts of propylene glycol monopropyl ether and 0.5 parts of t-butyl-2-ethylhexanoate was further added dropwise into a flask for 1 hour, and after completion of the dropwise addition, was aged for 1 hour. Subsequently 3.03 parts of 2-(dimethylamino)ethanol was added. Deionized water was gradually added to obtain a hydroxy-containing acrylic resin solution (A2-1) with a solids content of 40%. The resulting hydroxy-containing acrylic resin had an acid value of 27 mg KOH/g and a hydroxy value of 145 mg KOH/g.

### Production Example 5

A 30 part quantity of propylene glycol monopropyl ether were placed into a reaction vessel equipped with a thermometer, a thermostat, a stirrer, a reflux condenser, a nitrogen inlet tube and a dropping funnel, and heated to 85° C. A mixture of 6 parts of styrene, 30 parts of methyl methacrylate, 25 parts of n-butyl acrylate, 20 parts of 2-ethylhexyl acrylate, 13 parts of 4-hydroxybutyl acrylate, 6 parts of acrylic acid, 10 parts of propylene glycol monopropyl ether and 2 parts of 2,2′-azobis(2,4-dimethylvaleronitrile) was added dropwise into a flask over 4 hours, and after completion of the dropwise addition, was aged for 1 hour. A mixture of 5 parts of propylene glycol monopropyl ether and 1 part of 2,2′-azobis(2,4-dimethylvaleronitrile) was further added dropwise into a flask for 1 hour, and after completion of the dropwise addition, was aged for 1 hour. Further, 7.4 parts of 2-(dimethylamino)ethanol was added to neutralize. Deionized water was gradually added to obtain a hydroxy-containing acrylic resin solution (A2-2) with a solids content of 40%. The resulting hydroxy-containing acrylic resin had an acid value of 47 mg KOH/g and a hydroxy value of 51 mg KOH/g.

### Production Example 6

A 15 part quantity of propylene glycol monomethyl ether and 25 parts of propylene glycol monobutyl ether were placed into a reaction vessel equipped with a thermometer, a thermostat, a stirrer, a reflux condenser, a nitrogen inlet tube and a dropping funnel, and maintained at 110° C. with heating and stirring. Into the reaction vessel, a mixture consisting of 40 parts of 50% water dilution of methoxy polyethylene glycol mono-methacrylate (trade name “NF BISOMER S20W”, a product of Dai-Ichi Kogyo Seiyaku Co., Ltd.), 19 parts of 4-hydroxybutyl acrylate, 5 parts of N,N-dimethylaminoethyl methacrylate, 2 parts of 2-(methacryloyloxy)ethyl trimethyl ammonium chloride, 5 parts of styrene, 20 parts of isobornylacrylate, 19 parts of methyl methacrylate, 10 parts of n-butyl acrylate, 1 parts of azobis isobutyronitrile and 20 parts of propylene glycol monopropyl ether was added dropwise over 3 hours, and then was aged at 110° C. for 30 minutes. Subsequently, an additional catalytic mixture consisting of 15 parts of propylene glycol monomethyl ether and 0.5 parts of azobis isobutyronitrile was added dropwise over 1 hour, further aged at 110° C. for 1 hour, and cooled to obtain a hydroxy-containing acrylic resin solution (A2-3) with a solids content of 50%. The resulting hydroxy-containing acrylic resin had a hydroxy value of 74 mg KOH/g.

### Production Example 7

A 70.7 part quantity of deionized water and 0.52 parts of Aqualon KH-10 (refer to Note 1 below) were placed into a reaction vessel equipped with a thermometer, a thermostat, a stirrer, a reflux condenser, a nitrogen inlet tube and a dropping funnel, stirred and mixed in a nitrogen flow, and heated to 80° C. Subsequently, 1% of the total amount of the below emulsified monomer (refer to Note 2 below) and 5 parts of 6% ammonium persulfate solution were introduced into a reaction vessel, and maintained at 80° C. for 15 minutes. The remaining emulsified monomer was added dropwise into a reaction vessel over 3 hours while the same temperature was maintained. After completion of the dropwise addition, the reaction product was aged for 1 hour. Gradually adding 40 parts of 5% 2-(dimethylamino)ethanol solution into a reaction vessel, the reaction product was cooled to 30° C., and filtrated using 100 mesh polyamide (NYLON®) cloth to obtain a filtrate of a hydroxy-containing acrylic resin dispersion liquid (A2-4) with a solids content of 45%. The resulting hydroxy-containing acrylic resin had an acid value of 12 mg KOH/g and a hydroxy value of 43 mg KOH/g.

Note 1: Aqualon KH-10 is polyoxyethylene alkyl ether sulfate ester ammonium salt, a product of Dai-Ichi Kogyo Seiyaku Co., Ltd., having 97% active ingredient.

Note 2: Emulsified monomer is an emulsified monomer that was obtained by mixing and stirring 50 parts of deionized water, 10 parts of styrene, 40 parts of methyl methacrylate, 35 parts of ethylacrylate, 3.5 parts of n-butylmethacrylate, 10 parts of 2-hydroxyethylmethacrylate, 1.5 parts of acrylic acid, 1.0 parts of Aqualon KH-10 of and 0.03 parts of ammonium persulfate.

### Production of First Colored Coating Composition (X)

### Example 1

Fifty-six parts (resin solids content of 25 parts) of hydroxy-containing polyester resin solution (A1-1) obtained in Production Example 1, 60 parts of rutile titanium dioxide (D1-1) (trade name “JR-806”, a product of TAYCA CORP.), 1 part of carbon black (D1-2) (trade name “Carbon MA-100”, a product of Mitsubishi Chemical, Inc.), 15 parts of barium sulfate powder (D2-1) (trade name “Bariace B-35”, a product of Sakai Chemical Industry Co., Ltd.) with an average particle diameter of 0.5 μm, 3 parts of powdered talc (D2-2) (trade name “MICRO ACE S-3”, a product of Nippon Talc Co., Ltd) with an average particle diameter of 4.8 μm, and 5 parts of deionized water were mixed, adjusted to pH 8.0 using 2-(dimethylamino)ethanol, and dispersed using a paint shaker for 30 minutes so as to obtain pigment dispersion paste.

Next, 140 parts of the obtained a pigment dispersion paste, 10 parts of diester compound (C-1) described below, 23 parts of the hydroxy-containing polyester resin solution (A1-1) obtained in Production Example 1, 17 parts of the hydroxy-containing acrylic resin solution (A2-1) obtained in Production Example 4, 33 parts of the hydroxy-containing acrylic resin dispersion liquid (A2-4) obtained in Production Example 7, 33 parts of a melamine resin (B1-3-1) (methyl-butyl mixed ether melamine resin, solids content of 60%, a weight average molecular weight of 1,800), 26 parts of a blocked polyisocyanate compound (B3-1) (trade name “Bayhydrol VPLS2310”, a product of Sumika Bayel Urethane Co., Ltd., a solids content of 38%), 10 parts of 2-ethyl-1-hexanol (E-1) (mass dissolved in 100 g water at 20° C.: 0.1 g), and 43 parts of a urethane emulsion (F) (trade name “U Coat UX-8100”, a product of Sanyo Chemical Industries, Ltd., a solids content of 35%) were homogenously mixed.

Diester compound (C-1): a diester compound of polyoxyethylene glycol and n-hexanoic acid, the diester compound being represented by Formula 1, wherein R¹ and R² are each pentyl, R³ is ethylene, and m is 5, having a molecular weight of 434.

Subsequently, a urethane-associated thickener (trade name “UH-752”, a product of ADEKA Corporation), 2-(dimethylamino)ethanol and deionized water were added to the obtained mixture to prepare a first colored coating composition (X-1) that has a pH of 8.0, a solids content of 48%, and a viscosity of 30 seconds measured using a Ford Cup No. 4 at 20° C.

### Examples 2 to 29

### Comparative Examples 1 to 6

According to the compositions presented in Table 1, first colored coating compositions (X-2) to (X-29) and (X-32) to (X-37), each having a pH of 8.0, a solids content of the coating composition of 48%, and a viscosity of 30 seconds measured by Ford Cup No. 4 at 20° C., were obtained using the same method as in Example 1.

In Example 28, 10 parts of ethylene glycol mono-n-butylether (mass dissolved in 100 g of water at 20° C.: unlimited) was mixed instead of 2-ethyl-1-hexanol (E-1). In Comparative Example 3, 10 parts of polyol A (refer to Note 3 below) was further added in preparing the above-mentioned mixture. In Comparative Example 4, 10 parts of polyol B (refer to Note 4 below) was further added in preparing the above-mentioned mixture.

Note 3: Polyol A is polyethylene glycol, having a hydroxy value of 187 and a number average molecular weight of 600.

Note 4: Polyol B is polyesterdiol prepared using cyclohexanedimethanol and adipic acid. The polyesterdiol has first hydroxy groups at both ends, a hydroxy value of 235, and a number average molecular weight of 480.

Each diester compound (C-2) to (C-18) represented in Table 1 below is as follows.

Diester compound (C-2): a diester compound of polyoxyethylene glycol and 2-ethylbutanoic acid, the diester compound being represented by Formula 1, wherein R¹ and R² are sec-butyl, R³ is ethylene, and m is 7. This diester compound has a molecular weight of 522.

Diester compound (C-3): a diester compound of polyoxyethylene glycol and 2-ethylpentanoic acid, the diester compound being represented by Formula 1, wherein R¹ and R² are 2-ethylbutyl, R³ is ethylene, and m is 7. This diester compound has a molecular weight of 536.

Diester compound (C-4): a diester compound of polyoxyethylene glycol and benzoic acid, the diester compound being represented by Formula 1, wherein R¹ and R² are benzene rings, R³ is ethylene, and m is 7. This diester compound has a molecular weight of 536.

Diester compound (C-5): a diester compound of polyoxyethylene glycol and n-octanoic acid, the diester compound being represented by Formula 1, wherein R¹ and R² are heptyl, R³ is ethylene, and m is 7. This diester compound has a molecular weight of 578.

Diester compound (C-6): a diester compound of polyoxyethylene glycol and 2-ethylhexanoic acid, the diester compound being represented by Formula 1, wherein R¹ and R² are 2-ethylpentyl, R³ is ethylene, and m is 7. This diester compound has a molecular weight of 578.

Diester compound (C-7): a diester compound of polyoxyethylene glycol and n-nonoic acid, the diester compound being represented by Formula 1, wherein R¹ and R² are octyl, R³ is ethylene, and m is 7. This diester compound has a molecular weight of 606.

Diester compound (C-8): a diester compound of polyoxyethylene glycol and 2-ethylheptanoic acid, the diester compound being represented by Formula 1, wherein R¹ and R² are 2-ethyl hexyl, R³ is ethylene, and m is 7. This diester compound has a molecular weight of 606.

Diester compound (C-9): a diester compound of polyoxyethylene glycol and n-decanoic acid, the diester compound being represented by Formula 1, wherein R¹ and R² are nonyl, R³ is ethylene, and m is 7. This diester compound has a molecular weight of 634.

Diester compound (C-10): a diester compound of polyoxyethylene glycol and 2-ethyloctanoic acid, the diester compound being represented by Formula 1, wherein R¹ and R² are 2-ethylheptyl, R³ is ethylene, and m is 10. This diester compound has a molecular weight of 766.

Diester compound (C-11): a diester compound of polyoxyethylene glycol and n-dodecanoic acid, the diester compound being represented by Formula 1, wherein R¹ and R² are undecyl, R³ is ethylene, and m is 7. This diester compound has a molecular weight of 690.

Diester compound (C-12): a diester compound of polyoxyethylene glycol and n-octadecanoic acid, the diester compound being represented by Formula 1, wherein R¹ and R² are heptadecyl, R³ is ethylene, and m is 7. This diester compound has a molecular weight of 858.

Diester compound (C-13): a diester compound of polyoxyethylene glycol and 2-ethylhexanoic acid, the diester compound being represented by Formula 1, wherein R¹ and R² are 2-ethylpentyl, R³ is ethylene, and m is 3. This diester compound has a molecular weight of 402.

Diester compound (C-14): a diester compound of polyoxyethylene glycol and 2-ethylhexanoic acid, the diester compound being represented by Formula 1, wherein R¹ and R² are 2-ethylpentyl, R³ is ethylene, and m is 5. This diester compound has a molecular weight of 490.

Diester compound (C-15): a diester compound of polyoxyethylene glycol and 2-ethylhexanoic acid, the diester compound being represented by Formula 1, wherein R¹ and R² are 2-ethylpentyl, R³ is ethylene, and m is 10. This diester compound has a molecular weight of 710.

Diester compound (C-16): a diester compound of polyoxyethylene glycol and 2-ethylhexanoic acid, the diester compound being represented by Formula 1, wherein R¹ and R² are 2-ethylpentyl, R³ is ethylene, and m is 25. This diester compound has a molecular weight of 1370.

Diester compound (C-17): a diester compound of polyoxyethylene glycol and n-butanoic acid, the diester compound being represented by Formula 1, wherein R¹ and R² are n-propyl, R³ is ethylene, and m is 7. This diester compound has a molecular weight of 466.

Diester compound (C-18): a diester compound of polyoxyethylene glycol and n-icosanoic acid, the diester compound being represented by Formula 1, wherein R¹ and R² are nonadecyl, R³ is ethylene, and m is 7. This diester compound has a molecular weight of 914.

### Example 30

A 56 part quantity (25 parts of a resin solids content) of the hydroxy-containing polyester resin solution (A1-1) obtained in Production Example 1, 60 parts of rutile titanium dioxide (D1-1) (trade name “JR-806”, a product of TAYCA CORP.), 1 part of carbon black (D1-2) (trade name “Carbon MA-100”, a product of Mitsubishi Chemical, Inc.), 15 parts of barium sulfate powder (D2-1) (trade name “Bariace B-35”, a product of Sakai Chemical Industry Co., Ltd.) having an average particle diameter of 0.5 μm, 3 parts of powdered talc (D2-2) (trade name “MICRO ACE S-3”, a product of Nippon Talc Co., Ltd) having an average particle diameter of 4.8 μm and 5 parts of deionized water were mixed. After being adjusted to pH 8.0 using 2-(dimethylamino)ethanol, the mixture was dispersed using a paint shaker for 30 minutes to obtain a pigment dispersion paste.

Next, 140 parts of the resulting pigment dispersion paste, 10 parts of the above diester compound (C-6), 23 parts of the hydroxy-containing polyester resin solution (A1-1) obtained in Production Example 1, 17 parts of the hydroxy-containing acrylic resin solution (A2-1) obtained in Production Example 4, 33 parts of the hydroxy-containing acrylic resin dispersion liquid (A2-4) obtained in Production Example 7, 33 parts of melamine resin (B1-3-1) (methyl-butyl mixed ether melamine resin, a solids content of 60%, a weight average molecular weight of 1,800), 26 parts of a blocked polyisocyanate compound (B3-1) (trade name “Bayhydrol VPLS2310”, a product of Sumika Bayel Urethane Co., Ltd., a solids content of 38%), 10 parts of 2-ethyl-1-hexanol (E-1) (mass dissolved in 100 g of water at 20° C.: 0.1 g) and 43 parts of a urethane emulsion (F) (trade name “U Coat UX-8100”, a product of Sanyo Chemical Industries, Ltd., a solids content of 35%) were homogenously mixed.

Subsequently, a polyacrylic acid thickener (trade name “Primal ASE-60”, a product of Rohm and Haas Company), 2-(dimethylamino)ethanol and deionized water were added to the resulting mixture to obtain a first colored coating composition (X-30) having a pH of 8.0, a solids content of the coating composition of 48%, and a viscosity of 30 seconds measured at 20° C. measured using a Ford Cup No. 4.

### Example 31

A 56 part quantity (25 parts of a resin solids content) of hydroxy-containing polyester resin solution (A1-1) obtained in Production Example 1, 60 parts of rutile titanium dioxide (D1-1) (trade name “JR-806”, a product of TAYCA CORP.), 1 part of carbon black (D1-2) (trade name “Carbon MA-100”, a product of Mitsubishi Chemical, Inc.), 15 parts of barium sulfate powder (D2-1) (trade name “Bariace B-35”, a product of Sakai Chemical Industry Co., Ltd.) having an average particle diameter of 0.5 μm, 3 parts of powdered talc (D2-2) (trade name “MICRO ACE S-3”, a product of Nippon Talc Co., Ltd) having an average particle diameter of 4.8 μm, and 5 parts of deionized water were mixed. After being adjusted to pH 8.0 with 2-(dimethylamino)ethanol, the mixture was dispersed using a paint shaker for 30 minutes to obtain a pigment dispersion paste.

Next, 140 parts of the resulting pigment dispersion paste, 10 parts of the above diester compound (C-6), 23 parts of the hydroxy-containing polyester resin solution (A1-1) obtained in Production Example 1, 17 parts of the hydroxy-containing acrylic resin solution (A2-1) obtained in Production Example 4, 33 parts of the hydroxy-containing acrylic resin dispersion liquid (A2-4) obtained in Production Example 7, 33 parts of melamine resin (B1-3-1) (methyl-butyl mixed ether melamine resin, solids content of 60%, weight average molecular weight of 1,800), 26 parts of a blocked polyisocyanate compound (B3-1) (trade name “Bayhydrol VPLS2310”, a product of Sumika Bayel Urethane Co., Ltd., a solids content of 38%), 10 parts of 2-ethyl-1-hexanol (E-1) (mass dissolved in 100 g water at 20° C.: 0.1 g) and 43 parts of urethane emulsion (F) (trade name “U Coat UX-8100”, a product of Sanyo Chemical Industries, Ltd., a solids content of 35%) were homogenously mixed.

Subsequently, 2-(dimethylamino)ethanol and deionized water were added to the resulting mixture to obtain a first colored coating composition (X-31) having a pH of 8.0, and a viscosity of 30 seconds measured at 20° C. using a Ford Cup No. 4.

TABLE 1

| | | | Example | | | | |
|---|---|---|---|---|---|---|---|
| | | | 1 | 2 | 3 | 4 | 5 |
| Name of Colored Coating | | | X1 | X2 | X3 | X4 | X5 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin (A) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |
| Hydroxy- | | Type | A1-1 | A1-1 | A1-1 | A1-1 | A1-1 |
| containing | | Amount | 23 | 23 | 23 | 23 | 23 |
| Polyester | | | | | | | |
| Resin (A1) | | | | | | | |
| Hydroxy- | | Type | A2-1 | A2-1 | A2-1 | A2-1 | A2-1 |
| containing | | Amount | 17 | 17 | 17 | 17 | 17 |
| Acrylic Resin | | Type | A2-4 | A2-4 | A2-4 | A2-4 | A2-4 |
| (A2) | | Amount | 33 | 33 | 33 | 33 | 33 |
| Curing Agent | | Type | B1-3-1 | B1-3-1 | B1-3-1 | B1-3-1 | B1-3-1 |
| (B) | | Amount | 33 | 33 | 33 | 33 | 33 |
| | | Type | B3-1 | B3-1 | B3-1 | B3-1 | B3-1 |
| | | Amount | 26 | 26 | 26 | 26 | 26 |
| Diester | | Type | C-1 | C-2 | C-3 | C-4 | C-5 |
| Compound | | Amount | 10 | 10 | 10 | 10 | 10 |
| (C) | | | | | | | |
| Hydrophobic | | Type | E-1 | E-1 | E-1 | E-1 | E-1 |
| Solvent | | Amount | 10 | 10 | 10 | 10 | 10 |
| (E) | | | | | | | |
| Urethane Emulsion (F) | | | 43 | 43 | 43 | 43 | 43 |
| | | | Example | | | | |
| | | | 6 | 7 | 8 | 9 | 10 |
| Name of Colored Coating | | | X6 | X7 | X8 | X9 | X10 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |
| Hydroxy- | | Type | A1-1 | A1-1 | A1-1 | A1-1 | A1-1 |
| containing | | Amount | 23 | 23 | 23 | 23 | 23 |
| Polyester | | | | | | | |
| Resin (A1) | | | | | | | |
| Hydroxy- | | Type | A2-1 | A2-1 | A2-1 | A2-1 | A2-1 |
| containing | | Amount | 17 | 17 | 17 | 17 | 17 |
| Acrylic Resin | | Type | A2-4 | A2-4 | A2-4 | A2-4 | A2-4 |
| (A2) | | Amount | 33 | 33 | 33 | 33 | 33 |
| Curing Agent | | Type | B1-3-1 | B1-3-1 | B1-3-1 | B1-3-1 | B1-3-1 |
| (B) | | Amount | 33 | 33 | 33 | 33 | 33 |
| | | Type | B3-1 | B3-1 | B3-1 | B3-1 | B3-1 |
| | | Amount | 26 | 26 | 26 | 26 | 26 |
| Diester | | Type | C-6 | C-7 | C-8 | C-9 | C-10 |
| Compound | | Amount | 10 | 10 | 10 | 10 | 10 |
| (C) | | | | | | | |
| Hydrophobic | | Type | E-1 | E-1 | E-1 | E-1 | E-1 |
| Solvent | | Amount | 10 | 10 | 10 | 10 | 10 |
| (E) | | | | | | | |
| Urethane Emulsion | | | 43 | 43 | 43 | 43 | 43 |
| (F) | | | | | | | |
| | | | Example | | | | |
| | | | 11 | 12 | 13 | 14 | 15 |
| Name of Colored Coating | | | X11 | X12 | X13 | X14 | X15 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |
| Hydroxy- | | Type | A1-1 | A1-1 | A1-1 | A1-1 | A1-1 |
| containing | | Amount | 23 | 23 | 23 | 23 | 23 |
| Polyester | | | | | | | |
| Resin (A1) | | | | | | | |
| Hydroxy- | | Type | A2-1 | A2-1 | A2-1 | A2-1 | A2-1 |
| containing | | Amount | 17 | 17 | 17 | 17 | 17 |
| Acrylic Resin | | Type | A2-4 | A2-4 | A2-4 | A2-4 | A2-4 |
| (A2) | | Amount | 33 | 33 | 33 | 33 | 33 |
| Curing Agent | | Type | B1-3-1 | B1-3-1 | B1-3-1 | B1-3-1 | B1-3-1 |
| (B) | | Amount | 33 | 33 | 33 | 33 | 33 |
| | | Type | B3-1 | B3-1 | B3-1 | B3-1 | B3-1 |
| | | Amount | 26 | 26 | 26 | 26 | 26 |
| Diester | | Type | C-11 | C-12 | C-13 | C-14 | C-15 |
| Compound | | Amount | 10 | 10 | 10 | 10 | 10 |
| (C) | | | | | | | |
| Hydrophobic | | Type | E-1 | E-1 | E-1 | E-1 | E-1 |
| Solvent | | Amount | 10 | 10 | 10 | 10 | 10 |
| (E) | | | | | | | |
| Urethane Emulsion | | | 43 | 43 | 43 | 43 | 43 |
| (F) | | | | | | | |
| | | | Example | | | | |
| | | | 16 | 17 | 18 | 19 | 20 |
| Name of Colored Coating | | | X16 | X17 | X18 | X19 | X20 |
| Composition | | | | | | | |
| Pigment Dispersion Paste | Hydroxy- | Type | A1-1 | A1-2 | A1-3 | A1-1 | A1-1 |
| | containing | Amount | 56 | 56 | 56 | 56 | 56 |
| | Polyester | | | | | | |
| | Resin (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |
| Hydroxy- | | Type | A1-1 | A1-2 | A1-3 | A1-1 | A1-1 |
| containing | | Amount | 23 | 23 | 23 | 23 | 23 |
| Polyester | | | | | | | |
| Resin (A1) | | | | | | | |
| Hydroxy- | | Type | A2-1 | A2-1 | A2-1 | A2-2 | A2-2 |
| containing | | Amount | 17 | 17 | 17 | 17 | 10 |
| Acrylic Resin | | Type | A2-4 | A2-4 | A2-4 | A2-4 | A2-4 |
| (A2) | | Amount | 33 | 33 | 33 | 33 | 25 |
| Curing Agent | | Type | B1-3-1 | B1-3-1 | B1-3-1 | B1-3-1 | B1-1-1 |
| (B) | | Amount | 33 | 33 | 33 | 42 | 38 |
| | | Type | B3-1 | B3-1 | B3-1 | B3-1 | — |
| | | Amount | 26 | 26 | 26 | 13 | — |
| Diester | | Type | C-16 | C-6 | C-6 | C-6 | C-6 |
| Compound | | Amount | 10 | 10 | 10 | 10 | 8 |
| (C) | | | | | | | |
| Hydrophobic | | Type | E-1 | E-1 | E-1 | E-1 | E-1 |
| Solvent | | Amount | 10 | 10 | 10 | 10 | 10 |
| (E) | | | | | | | |
| Urethane Emulsion | | | 43 | 43 | 43 | 43 | 57 |
| (F) | | | | | | | |
| | | | Example | | | | |
| | | | 21 | 22 | 23 | 24 | 25 |
| Name of Colored Coating | | | X21 | X22 | X23 | X24 | X25 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |

| | | | | | | |
|---|---|---|---|---|---|---|
| Hydroxy- | Type | A1-1 | A1-1 | A1-1 | A1-1 | A1-1 |
| containing | Amount | 15 | 15 | 66 | 23 | 23 |
| Polyester | | | | | | |
| Resin (A1) | | | | | | |
| Hydroxy- | Type | A2-2 | A2-3 | — | A2-1 | A2-1 |
| containing | Amount | 17 | 14 | — | 17 | 17 |
| Acrylic Resin | Type | A2-4 | A2-4 | — | A2-4 | A2-4 |
| (A2) | Amount | 33 | 33 | — | 33 | 33 |
| Curing Agent | Type | B1-1-1 | B1-1-1 | B1-3-1 | B1-3-1 | B1-1-1 |
| (B) | Amount | 32 | 32 | 42 | 49 | 24 |
| | Type | B3-1 | B3-1 | B3-1 | — | B3-1 |
| | Amount | 13 | 13 | 13 | — | 26 |
| Diester | Type | C-8 | C-6 | C-3 | C-6 | C-6 |
| Compound | Amount | 8 | 8 | 10 | 10 | 10 |
| (C) | | | | | | |
| Hydrophobic | Type | E-1 | E-1 | E-1 | E-1 | E-1 |
| Solvent | Amount | 15 | 15 | 10 | 10 | 10 |
| (E) | | | | | | |

| | | | | | |
|---|---|---|---|---|---|
| Urethane Emulsion | 50 | 50 | 43 | 43 | 43 |
| (F) | | | | | |

| | | | Example | | | | |
|---|---|---|---|---|---|---|---|
| | | | 26 | 27 | 28 | 29 | 30 |
| Name of Colored Coating | | | X26 | X27 | X28 | X29 | X30 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin | | | | | | |
| | (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-3 | D2-1 | D2-1 | D2-1 | D2-1 |
| | Pigment | Amount | 15 | 15 | 15 | 15 | 15 |
| | (D2) | Type | D2-2 | — | D2-2 | D2-2 | D2-2 |
| | | Amount | 3 | — | 3 | 3 | 3 |

| | | | | | | | |
|---|---|---|---|---|---|---|---|
| Hydroxy- | Type | A1-1 | A1-1 | A1-1 | A1-1 | A1-3 | A1-1 |
| containing | Amount | 23 | 23 | 23 | 18 | 23 | 23 |
| Polyester | | | | | | | |
| Resin (A1) | | | | | | | |

| | | | | | | |
|---|---|---|---|---|---|---|
| Hydroxy- | Type | A2-1 | A2-1 | A2-1 | A2-1 | A2-1 |
| containing | Amount | 17 | 17 | 17 | 17 | 17 |
| Acrylic Resin | Type | A2-4 | A2-4 | A2-4 | A2-4 | A2-4 |
| (A2) | Amount | 33 | 33 | 33 | 33 | 33 |
| Curing Agent | Type | B1-3-1 | B1-3-1 | B1-3-1 | B1-3-1 | B1-3-1 |
| (B) | Amount | 33 | 33 | 33 | 45 | 33 |
| | Type | B3-1 | B3-1 | B3-1 | B3-1 | B3-1 |
| | Amount | 26 | 26 | 26 | 26 | 26 |
| Diester | Type | C-6 | C-8 | C-6 | C-3 | C-6 |
| Compound | Amount | 10 | 10 | 10 | 10 | 10 |
| (C) | | | | | | |
| Hydrophobic | Type | E-1 | E-1 | — | E-1 | E-1 |
| Solvent | Amount | 10 | 10 | — | 10 | 10 |
| (E) | | | | | | |

| | | | | | |
|---|---|---|---|---|---|
| Urethane Emulsion | 43 | 43 | 43 | — | 43 |
| (F) | | | | | |

| | | | Example | Comparison Example | | | |
|---|---|---|---|---|---|---|---|
| | | | 31 | 1 | 2 | 3 | 4 |
| Name of Colored Coating | | | X31 | X32 | X33 | X34 | X35 |
| Composition | | | | | | | |
| Pigment Dispersion Paste | Hydroxy- | Type | A1-1 | A1-1 | A1-1 | A1-1 | A1-1 |
| | containing | Amount | 56 | 56 | 56 | 56 | 56 |
| | Polyester | | | | | | |
| | Resin (A1) | | | | | | |
| | Coloring | Type | D1-1 | D1-1 | D1-1 | D1-1 | D1-1 |
| | Pigment | Amount | 60 | 60 | 60 | 60 | 60 |
| | (D1) | Type | D1-2 | D1-2 | D1-2 | D1-2 | D1-2 |
| | | Amount | 1 | 1 | 1 | 1 | 1 |
| | Extender | Type | D2-1 | D2-1 | D2-1 | D2-1 | D2-1 |
| | Pigment | Amount | 15 | 15 | 15 | 15 | 15 |
| | (D2) | Type | D2-2 | D2-2 | D2-2 | D2-2 | D2-2 |
| | | Amount | 3 | 3 | 3 | 3 | 3 |

| | | | | | | |
|---|---|---|---|---|---|---|
| Hydroxy- | Type | A1-1 | A1-1 | A1-1 | A1-1 | A1-1 |
| containing | Amount | 23 | 23 | 15 | 23 | 23 |
| Polyester | | | | | | |
| Resin (A1) | | | | | | |
| Hydroxy- | Type | A2-1 | A2-1 | A2-2 | A2-1 | A2-1 |
| containing | Amount | 17 | 17 | 17 | 17 | 17 |
| Acrylic Resin | Type | A2-4 | A2-4 | A2-4 | A2-4 | A2-4 |
| (A2) | Amount | 33 | 33 | 33 | 33 | 33 |
| Curing Agent | Type | B1-3-1 | B1-3-1 | B1-1-1 | B1-3-1 | B1-3-1 |
| (B) | Amount | 33 | 33 | 32 | 33 | 33 |
| | Type | B3-1 | B3-1 | B3-1 | B3-1 | B3-1 |
| | Amount | 26 | 26 | 13 | 26 | 26 |
| Diester | Type | C-6 | — | — | — | — |
| Compound | Amount | 10 | — | — | — | — |
| (C) | | | | | | |
| Hydrophobic | Type | E-1 | E-1 | E-1 | E-1 | E-1 |
| Solvent | Amount | 10 | 10 | 15 | 10 | 10 |
| (E) | | | | | | |

| | | | | | |
|---|---|---|---|---|---|
| Urethane Emulsion | 43 | 43 | 43 | 43 | 43 |
| (F) | | | | | |

Comparison
Example

| | | | 5 | 6 |
|---|---|---|---|---|
| Name of Colored Coating | | | X36 | X37 |
| Composition | | | | |
| Pigment Dispersion Paste | Hydroxy- | Type | A1-1 | A1-1 |
| | containing | Amount | 56 | 56 |
| | Polyester | | | |
| | Resin (A1) | | | |
| | Coloring | Type | D1-1 | D1-1 |
| | Pigment | Amount | 60 | 60 |
| | (D1) | Type | D1-2 | D1-2 |
| | | Amount | 1 | 1 |
| | Extender | Type | D2-1 | D2-1 |
| | Pigment | Amount | 15 | 15 |
| | (D2) | Type | D2-2 | D2-2 |
| | | Amount | 3 | 3 |

| | | | |
|---|---|---|---|
| Hydroxy- | Type | A1-1 | A1-1 |
| containing | Amount | 23 | 23 |
| Polyester | | | |
| Resin (A1) | | | |
| Hydroxy- | Type | A2-1 | A2-1 |
| containing | Amount | 17 | 17 |
| Acrylic Resin | Type | A2-4 | A2-4 |
| (A2) | Amount | 33 | 33 |
| Curing Agent | Type | B1-3-1 | B1-3-1 |
| (B) | Amount | 33 | 33 |
| | Type | B3-1 | B3-1 |
| | Amount | 26 | 26 |
| Diester | Type | C-17 | C-18 |
| Compound | Amount | 10 | 10 |
| (C) | | | |
| Hydrophobic | Type | E-1 | E-1 |
| Solvent | Amount | 10 | 10 |
| (E) | | | |

| | | |
|---|---|---|
| Urethane Emulsion | 43 | 43 |
| (F) | | |

D2-3: barium sulfate powder having an average primary particle diameter of 1.6 μm (trade name “SPARWITE W-5HB”, a product of Wilbur-Ellis Co.)
B1-1-1: melamine resin (methyl-etherified melamine resin, a solid content of 80%, a weight average molecular weight of 800)

### Production Example of Acrylic Resin Emulsion for an Aqueous Second Colored Coating Composition (Y)

### Production Example 8

A 130 part quantity of deionized water and 0.52 parts of Aqualon KH-10 (refer to Note 1 above) were placed into a reaction vessel equipped with a thermometer, a thermostat, a stirrer, a reflux condenser, a nitrogen inlet tube and a dropping funnel, stirred and mixed in a nitrogen flow, and heated to 80° C. Next, 1% of the total amount of the emulsified monomer below (1) and 5.3 parts of 6% ammonium persulfate solution were introduced into the reaction vessel and maintained at 80° C. for 15 minutes. Subsequently, the remaining emulsified monomer was added dropwise into a reaction vessel over 3 hours where the reaction vessel was maintained at the same temperature. After completion of the dropwise addition, the reaction product was aged for 1 hour. Subsequently, the emulsified monomer below (2) was added dropwise over 1 hour. After aging for 1 hour, the reaction product was cooled to 30° C. while gradually adding 40 parts of 5% dimethylethanolamine solution into a reaction vessel, and filtrated using polyamide (NYLON®) cloth with 100 meshes to obtain a filtrate of acrylic resin dispersion (AC) having a mean particle diameter of 100 nm and a solid content of 30%.

After diluting the dispersion with deionized water, the mean particle diameter was measured using the submicron particle size distribution analyzer (“COULTER N4”, a product of Beckman Coulter, Inc.) at 20° C.

The resulting acrylic resin had an acid value of 33 mg KOH/g and a hydroxy value of 25 mg KOH/g.

Emulsified monomer (1): 42 parts of deionized water, 0.72 parts of Aqualon KH-10, 2.1 parts of methylene-bis-acrylamide, 2.8 parts of styrene, 16.1 parts of methyl methacrylate, 28 parts of ethyl acrylate and 21 parts of n-butyl acrylate were mixed and stirred to obtain an emulsified monomer (1).

Emulsified monomer (2): 18 parts of deionized water 1, 0.31 parts of Aqualon KH-10, 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate and 9 parts of n-butyl acrylate were mixed and stirred to obtain an emulsified monomer (2).

### Product of Polyester Resin for an Aqueous Second Colored Coating Composition (Y)

### Production Example 9

A 109 part quantity of trimethylolpropane, 141 parts of 1,6-hexanediol, 126 parts of hexahydrophthalic anhydride and 120 parts of adipic acid were placed into a reaction vessel equipped with a thermometer, a thermostat, a stirrer, a reflux condenser and a water separator, and were heated from 160° C. to 230° C. over 3 hours, followed by a condensation reaction at 230° C. for 4 hours. Subsequently, in adding carboxyl group to the resulting condensation reaction product, 38.3 parts of trimellitic anhydride was further added, and allowed to react at 170° C. for 30 minutes. The reaction product was diluted with 2-ethyl-1-hexanol (mass dissolved in 100 g of water at 20° C.: 0.1 g) to obtain a polyester resin solution (PE1) with a solid content of 70%. The resulting polyester resin had an acid value of 46 mg KOH/g, a hydroxy value of 150 mg KOH/g, and a weight average molecular weight of 6,400.

### Production Example 10

A polyester resin solution (PE2) was obtained in the same manner as in Production Example 9, except that ethylene glycolmono-n-butyl ether (the mass dissolved in 100 g of water at 20° C.: unlimited) was used in place of 2-ethyl-1-hexanol.

### Production Example of Luster Pigment Dispersion

### Production Example 11

In a stirring and mixing container, 19 parts of an aluminium pigment paste (trade name “GX-180A”, a product of Asahi Kasei Metals Co., Ltd., a metal content of 74%), 35 parts of 2-ethyl-1-hexanol, 8 parts of a phosphate group containing resin solution (refer to Note 5 below) and 0.2 parts of 2-(dimethylamino)ethanol were homogenously mixed to obtain a luster pigment dispersion (P1).

Note 5: The phosphate group containing resin solution was prepared as follows. A solvent mixture consisting of 27.5 parts of methoxypropanol and 27.5 parts of isobutanol was put into a reaction vessel equipped with a thermometer, a thermostat, a stirrer, a reflux condenser, a nitrogen inlet tube and a dropping funnel, and was heated to 110° C. Subsequently, 121.5 parts of the mixture consisting of 25 parts of styrene, 27.5 parts of n-butyl methacrylate, 20 parts of branched higher alkyl acrylate (trade name: “isostearyl acrylate”, product of Osaka Organic Chemical Industry, Ltd.), 7.5 parts of 4-hydroxybutyl acrylate, 15 parts of a phosphate group containing polymerizable monomer (refer to Note 6 below), 12.5 parts of 2-methacryloyloxy ethyl acid phosphate, 10 parts of isobutanol and 4 parts of t-butyl peroxyoctanoate were added to the above solvent mixture over 4 hours. Subsequently, a mixture consisting of 0.5 parts of t-butyl peroxyoctanoate and 20 parts of isopropanol was added dropwise to the mixture obtained as above over 1 hour. Subsequently, the resulting mixture was matured over 1 hour with stirring to obtain phosphate group containing resin solution with a solid content of 50%. The phosphate group containing resin had an acid value of phosphate group of 83 mg KOH/g, a hydroxy value of 29 mg KOH/g, and a weight average molecular weight of 10,000.

Note 6: The phosphate group containing a polymerizable monomer as prepared as follows. 57.5 parts of monobutyl phosphate and 41 parts of isobutanol were put into a reaction vessel equipped with a thermometer, a thermostat, a stirrer, a reflux condenser, a nitrogen inlet tube and a dropping funnel, and were heated to 90° C. Subsequently, 42.5 parts of glycidyl methacrylate was added dropwise over 2 hours. After further aging for 1 hour with stirring, 59 parts of isopropanol was added to the obtained phosphate group containing the polymerizable monomer solution with a solid content of 50%. The resulting monomer had an acid value of 285 mg KOH/g by the phosphate group.

### Production Example 12

A luster pigment dispersion (P2) was obtained in the same manner as in Production Example 11, except that ethylene glycolmono-n-butyl ether was used in place of 2-ethyl-1-hexanol.

### Production Example of a Pigment Dispersion Paste for an Aqueous Second Colored Coating Composition (Y)

### Production Example 13

A 56 part quantity (25 parts of a resin solid content) of the hydroxy-containing polyester resin solution (A1-1) obtained in Production Example 1, 60 parts of rutile titanium dioxide (trade name “JR-806”, a product of Tayca Corp.) and 5 parts of deionized water were mixed. After adjusting to pH8.0 with 2-(dimethylamino)ethanol, the mixture was dispersed by a paint shaker for 30 minutes to obtain a pigment dispersion paste.

### Product of an Aqueous Second Colored Coating Composition (Y)

### Production Example 14

A 100 part quantity of the acrylic resin emulsion (AC) obtained in Production Example 8, 57 parts of the polyester resin solution (PE1) obtained in Production Example 9, 62 parts of the luster pigment dispersion (P1) obtained in Production Example 11 and 37.5 parts of the melamine resin (trade name “Cymel 325”, a product of Japan Cytec Industries, Inc., a solid content of 80%) were homogenously mixed, and a polyacrylic acid thickener (trade name “Primal ASE-60”, a product of Rohm and Haas Company), 2-(dimethylamino)ethanol and deionized water were further added to obtain a second aqueous colored coating composition (Y-1) having pH of 8.0, a coating solid content of 25%, and a viscosity of 40 seconds measured by Ford Cup No. 4 at 20° C.

### Production Example 15

A 100 part quantity of the acrylic resin emulsion (AC) obtained in Production Example 8, 57 parts of the polyester resin solution (PE2) obtained in Production Example 10, 62 parts of the luster pigment dispersion (P2) obtained in Production Example 12 and 37.5 parts of melamine resin (trade name “Cymel 325”, a product of Japan Cytec Industries, Inc., a solid content of 80%) were homogenously mixed, and a polyacrylic acid thickener (trade name “Primal ASE-60”, a product of Rohm and Haas Company), 2-(dimethylamino)ethanol and deionized water were further added to obtain a second aqueous colored coating composition (Y-2) having pH of 8.0, a coating a solid content of 25%, and a viscosity of 40 seconds measured by Ford Cup No. 4 at 20° C.

### Production Example 16

A 100 part quantity of the acrylic resin emulsion (AC) obtained in Production Example 8, 21 parts of the polyester resin solution (PE1) obtained in Production Example 9, 121 parts of the pigment dispersion paste obtained in Production Example 13, 35 parts of 2-ethyl-1-hexanol and 37.5 parts of melamine resin (trade name “Cymel 325”, a product of Japan Cytec Industries, Inc., a solid content 80%) were homogenously mixed, and a polyacrylic acid thickener (trade name “Primal ASE-60”, a product of Rohm and Haas Company), 2-(dimethylamino)ethanol and deionized water were further added to obtain a second aqueous colored coating composition (Y-3) having pH of 8.0, a coating solid content of 48%, and a viscosity of 60 seconds measured by Ford Cup No. 4 at 20° C.

### Preparation of Test Specimen

The first colored coating compositions (X-1) to (X-37) obtained in Examples 1 to 31 and Comparative Examples 1 to 6, and the second aqueous colored coating compositions (Y-1) to (Y-3) obtained in Production Examples 14 to 16 were used to make test specimens, and evaluation tests were performed according to the methods given below.

### Production of Testing Substrate to be Coated

A zinc phosphate-treated cold-rolled steel sheet was electrocoated with a cationic electrodeposition coating composition (trade name “ELECRON GT-10”, a product of Kansai Paint Co., Ltd.) by electrodeposition to form a cured film with a thickness of 20 μm. The coated sheet was heated at 170° C. for 30 minutes to cure the coating film, thus creating a testing substrate to be coated.

### Example 32

The testing substrate obtained was electrostatically coated with the first colored coating composition (X-1) obtained in Example 1 using a rotary atomizing electrostatic coating machine to form a cured film with a thickness of 25 μm. After being left for 2 minutes, the coated substrate was preheated at 80° C. for 3 minutes. Next, on the resulting uncured first colored coating film, the second aqueous colored coating composition (Y-1) obtained in Production Example 14 was electrostatically coated using a rotary atomizing electrostatic coating machine to form a second cured film with a thickness of 15 μm. After being left for 2 minutes, the doubly coated substrate was preheated for 3 minutes at 80° C. After further heating at 140° C. for 30 minutes, the above first colored coating film and the second colored coating film were simultaneously cured. Subsequently, on the cured second colored coating film, an acrylic resin organic solvent-based clear topcoat composition (trade name “Magicron KINO-1210”, a product of Kansai Paint Co. Ltd., hereinafter abbreviated as “a clear coating composition (Z-1)”) was electrostatically coated to form a cured film with a thickness of 35 μm. After being left for 7 minutes, the topcoated substrate was heated at 140° C. for 30 minutes to cure the resulting clear coating film. Thus, test specimen was produced.

### Examples 33 to 62

### Comparative Examples 7 to 12

Each test specimen was produced following the steps in Example 32 except that the coating compositions each presented in Table 2 were used for first colored coating composition.

### Example 63

Each test specimen was produced in the same manner as in Example 37 except that the second aqueous colored coating composition (Y-2) obtained in Production Example 15 was used in place of the second aqueous colored coating composition (Y-1) for a second colored coating composition.

### Example 64

On the testing substrate to be coated, the first colored coating composition (X-1) obtained in Example 1 was electrostatically coated using a rotary atomizing electrostatic coating machine to form a cured film with a thickness of 25 μm. After being left for 2 minutes, the coated substrate was preheated at 80° C. for 3 minutes. Next, on the resulting uncured first colored coating film, the second aqueous colored coating composition (Y-3) obtained in Production Example 16 was electrostatically coated using a rotary atomizing electrostatic coating machine to form a cured film with a thickness of 35 μm. After being left 2 minutes, the coated substrate was preheated at 80° C. for 3 minutes. Subsequently, the coated substrate was heated at 140° C. for 30 minutes to simultaneously cure the above first colored coating film and the second colored coating film. Thus, each test specimen was produced.

### Examples 65 to 94

### Comparative Examples 13 to 18

Each test specimen was produced using the same method as in Example 64 except that the coating composition presented in Table 3 was used for the first colored coating composition.

### Evaluation Test

Each test specimen obtained in Examples 32 to 94 and Comparative Examples 7 to 18 was evaluated according to the test method below. Table 2 and Table 3 show results of the evaluation tests.

### Test Methods

Smoothness: Smoothness was evaluated using the Wb values measured by “Wave Scan DOI” (a product of BYK-Gardner). The smaller the Wb value is, the greater the smoothness of the coating surface. In Table 2 and Table 3, “initial” means the smoothness of the first colored coating composition (X) that is coated immediately after the production, and “post-storage” means the smoothness of the first colored coating composition (X) that is stored at 30° C. for 30 days after the production and is subsequently coated.

Water resistance: Each test specimen was immersed in 40° C. warm water for 240 hours and then removed and dried for 12 hours. Subsequently, crosscuts reaching the substrate were made in the multilayer coating film on the test specimen using a cutter knife to form a grid of 100 squares (2 mm×2 mm). Subsequently, an adhesive cellophane tape was applied to the surface of the crosscut coating film and abruptly peeled off at 20° C. The remainability of the crosscut coating film squares was then checked.

A: 100 cuts in the film remained, and no small edge chipping occurred at the cutting edges made by the cutter knife.
B: 100 cuts in the film remained, but small edge chipping occurred at the cutting edges made by the cutter knife.
C: 90 to 99 cuts in the film remained.
D: The number of remaining cuts in the film was 89 or less.

Flip flop effect: Each test specimen was visually observed from various angles, and flip flop effect was evaluated on the metallic appearance basis below.

A: There were significant changes in the metallic appearance visually observed (possesses exceedingly excellent flip flop effect).
B: There were large changes in the metallic appearance visually observed (excellent flip flop effect).
C: There was relatively little change in the metallic appearance visually observed (slightly poor flip flop effect).
D: There was little change in the metallic appearance visually observed (poor flip flop effect).

Metallic mottling: Each test specimen was visually observed, and the occurrence of metallic mottling was evaluated on the following basis.

A: No substantial metallic mottling was observed, and the coating film had an excellent appearance.
B: A small amount of metallic mottling was observed, but the coating film had an excellent appearance.
C: Metallic mottling was observed, and the coating film had a relatively poor appearance.
D: A considerable amount of metallic mottling was observed, and the coating film had a poor appearance.

Chipping resistance properties: Each test specimen was mounted on a test specimen holder of a gravel test instrument (chipping test apparatus) (trade name “JA-400 type”, a product of Suga Test Instruments Co., Ltd.), followed by spraying 50 g of granite gravel having a particle size of No. 7 onto the surface of a coating film under an air pressure of 0.392 MPa (4 kgf/cm.sup.2) at an angle of 45′ at −20° C. Subsequently, the resulting test specimen was washed with water and dried. A cloth adhesive tape (a product of Nichiban Co., Ltd.) was applied to the coated surface. Subsequently, the above tape was peeled off to visually evaluate the degree of development of mars on the coating film.

A: Sizes of mars were exceedingly small, and the electrodeposition surface and the substrate of steel sheet were not exposed.
B: Sizes of mars were small, and the electrodeposition surface and the substrate of the steel sheet were not exposed.
C: Sizes of mars were small, but the electrodeposition surface or the substrate of the steel sheet was exposed.
D: Sizes of mars were considerably large, and the substrate of the steel sheet was largely exposed.

TABLE 2

| | Example | | | | | | | |
|---|---|---|---|---|---|---|---|---|
| | 32 | 33 | 34 | 35 | 36 | 37 | 38 | 39 |
| First Coloring Pigment | X1 | X2 | X3 | X4 | X5 | X6 | X7 | X8 |
| Composition (X) | | | | | | | | |
| Smoothness | 15.3 | 15.1 | 13.7 | 14.2 | 13.3 | 13.1 | 13.7 | 13.5 |
| (Initial) | | | | | | | | |
| Smoothness | 16.6 | 15.6 | 14.2 | 14.8 | 14.5 | 13.7 | 14.6 | 14.1 |
| (Post-storage) | | | | | | | | |
| Water Resistance | B | A | A | A | A | A | A | A |
| Flip Flop effect | B | A | A | A | A | A | A | A |
| Metallic Mottling | B | A | A | A | A | A | A | A |
| Chipping Resistance | A | A | A | A | A | A | A | A |
| | Example | | | | | | | |
| | 40 | 41 | 42 | 43 | 44 | 45 | 46 | 47 |
| First Coloring Pigment | X9 | X10 | X11 | X12 | X13 | X14 | X15 | X16 |
| Composition (X) | | | | | | | | |
| Smoothness | 14.3 | 14.9 | 15.4 | 15.7 | 15.5 | 13.6 | 15.2 | 15.8 |
| (Initial) | | | | | | | | |
| Smoothness | 15.8 | 15.4 | 16.5 | 16.8 | 16.0 | 14.0 | 15.3 | 16.9 |
| (Post-storage) | | | | | | | | |
| Water Resistance | A | A | B | B | B | A | B | B |
| Flip Flop effect | B | A | B | B | B | A | A | B |
| Metallic Mottling | B | A | B | B | B | A | B | B |
| Chipping Resistance | A | A | A | A | A | A | A | A |
| | Example | | | | | | | |
| | 48 | 49 | 50 | 51 | 52 | 53 | 54 | 55 |
| First Coloring Pigment | X17 | X18 | X19 | X20 | X21 | X22 | X23 | X24 |
| Composition (X) | | | | | | | | |
| Smoothness | 13.6 | 13.9 | 13.0 | 13.1 | 13.4 | 13.3 | 14.2 | 13.1 |
| (Initial) | | | | | | | | |
| Smoothness | 14.2 | 14.4 | 13.5 | 13.8 | 13.9 | 13.8 | 14.6 | 13.8 |
| (Post-storage) | | | | | | | | |
| Water Resistance | A | B | A | B | B | B | B | A |
| Flip Flop effect | A | A | A | A | A | A | A | A |
| Metallic Mottling | A | A | A | A | A | A | A | A |
| Chipping Resistance | B | A | A | A | A | A | A | B |
| | Example | | | | | | | |
| | 56 | 57 | 58 | 59 | 60 | 61 | 62 | 63 |
| First Coloring Pigment | X25 | X26 | X27 | X28 | X29 | X30 | X31 | X6 |
| Composition (X) | | | | | | | | |
| Smoothness | 13.2 | 13.8 | 13.6 | 13.5 | 13.8 | 13.4 | 13.8 | 13.2 |
| (Initial) | | | | | | | | |
| Smoothness | 13.7 | 14.3 | 14.3 | 14.1 | 14.3 | 14.0 | 14.4 | 13.8 |
| (Post-storage) | | | | | | | | |
| Water Resistance | B | A | A | A | A | A | A | A |
| Flip Flop effect | A | A | A | A | A | A | A | B |
| Metallic Mottling | A | A | A | A | A | A | A | B |
| Chipping Resistance | B | A | B | A | B | A | A | A |

Comparison Example

| | 7 | 8 | 9 | 10 | 11 | 12 |
|---|---|---|---|---|---|---|
| First Coloring Pigment | X32 | X33 | X34 | X35 | X36 | X37 |
| Composition (X) | | | | | | |
| Smoothness | 23.6 | 23.6 | 21.0 | 21.5 | 22.2 | 23.5 |
| (Initial) | | | | | | |
| Smoothness | 24.7 | 24.5 | 22.1 | 22.8 | 24.2 | 25.8 |
| (Post-storage) | | | | | | |
| Water Resistance | B | C | B | B | B | C |
| Flip Flop effect | D | D | C | C | D | D |
| Metallic Mottling | D | D | C | C | D | D |
| Chipping Resistance | B | B | B | B | B | B |

TABLE 3

| | Example | | | | | | | |
|---|---|---|---|---|---|---|---|---|
| | 64 | 65 | 66 | 67 | 68 | 69 | 70 | 71 |
| First Coloring Pigment | X1 | X2 | X3 | X4 | X5 | X6 | X7 | X8 |
| Composition (X) | | | | | | | | |
| Smoothness (Initial) | 16.5 | 16.3 | 14.9 | 15.4 | 14.3 | 14.0 | 14.9 | 14.5 |
| Smoothness (Post- | 17.7 | 16.8 | 15.3 | 15.9 | 15.6 | 14.8 | 15.7 | 15.2 |
| storage) | | | | | | | | |
| Water Resistance | B | A | A | A | A | A | A | A |
| Chipping Resistance | A | A | A | A | A | A | A | A |
| | Example | | | | | | | |
| | 72 | 73 | 74 | 75 | 76 | 77 | 78 | 79 |
| First Coloring Pigment | X9 | X10 | X11 | X12 | X13 | X14 | X15 | X16 |
| Composition (X) | | | | | | | | |
| Smoothness (Initial) | 15.5 | 16.1 | 16.6 | 16.8 | 16.7 | 14.8 | 16.4 | 16.9 |
| Smoothness | 17.0 | 16.7 | 17.6 | 17.9 | 17.1 | 15.1 | 16.6 | 18.0 |
| (Post-storage) | | | | | | | | |
| Water Resistance | A | A | B | B | B | A | B | B |
| Chipping Resistance | A | A | A | A | A | A | A | A |
| | Example | | | | | | | |
| | 80 | 81 | 82 | 83 | 84 | 85 | 86 | 87 |
| First Coloring Pigment | X17 | X18 | X19 | X20 | X21 | X22 | X23 | X24 |
| Composition (X) | | | | | | | | |
| Smoothness | 14.8 | 15.1 | 14.2 | 14.1 | 14.5 | 14.4 | 15.4 | 14.3 |
| (Initial) | | | | | | | | |
| Smoothness | 15.3 | 15.5 | 14.6 | 14.8 | 15.0 | 14.8 | 15.7 | 14.9 |
| (Post-storage) | | | | | | | | |
| Water Resistance | A | B | A | B | B | B | B | A |
| Chipping Resistance | B | A | A | A | A | A | A | B |

| | Example | | | | | | |
|---|---|---|---|---|---|---|---|
| | 88 | 89 | 90 | 91 | 92 | 93 | 94 |
| First Coloring Pigment | X25 | X26 | X27 | X28 | X29 | X30 | X31 |
| Composition (X) | | | | | | | |
| Smoothness | 14.4 | 15.0 | 14.8 | 14.7 | 15.0 | 14.6 | 15.0 |
| (Initial) | | | | | | | |
| Smoothness | 14.8 | 15.4 | 15.4 | 15.2 | 15.4 | 15.1 | 15.5 |
| (Post-storage) | | | | | | | |
| Water Resistance | B | A | A | A | A | A | A |
| Chipping Resistance | B | A | B | A | B | A | A |

Comparison Example

| | 13 | 14 | 15 | 16 | 17 | 18 |
|---|---|---|---|---|---|---|
| First Coloring Pigment | X32 | X33 | X34 | X35 | X36 | X37 |
| Composition (X) | | | | | | |
| Smoothness | 24.2 | 24.8 | 22.2 | 22.8 | 23.6 | 24.6 |
| (Initial) | | | | | | |
| Smoothness | 25.2 | 25.7 | 23.2 | 23.9 | 24.7 | 24.9 |
| (Post-storage) | | | | | | |
| Water Resistance | B | C | B | B | B | C |
| Chipping Resistance | B | B | B | B | B | B |

1. A colored coating composition comprising:
(A) a hydroxy-containing resin,
(B) a curing agent,
(C) a diester compound represented by Formula (1) 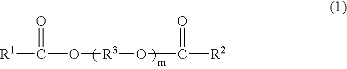
wherein R¹ and R² are each independently a C₄₋₁₈ hydrocarbon group, R³ is a C₂₋₄ alkylene group, m is an integer of 3 to 25, and m oxyalkylene units (R³—O) may be the same or different,
(D1) a coloring pigment, and
(D2) an extender pigment;
the total amount of the coloring pigment (D1) and the extender pigment (D2) being 40 to 180 parts by mass per 100 parts by mass of the hydroxy-containing resin (A) and the curing agent (B) in total.

2. A colored coating composition according to claim 1, wherein the hydroxy-containing resin (A) is at least one member selected from the group consisting of a hydroxy-containing polyester resin (A1) and a hydroxy-containing acrylic resin (A2).

3. A colored coating composition according to claim 2, wherein the hydroxy-containing polyester resin (A1) is a hydroxy-containing polyester resin obtained by reacting an acid component (a1-1) containing 30 mol % or more of an aliphatic polybasic acid (a1-1-1) and an alicyclic polybasic acid (a1-1-2) in total, with an alcohol component (a1-2).

4. A colored coating composition according to claim 1, wherein the diester compound (C) is a diester compound of a polyoxyalkylene glycol with an aliphatic monocarboxylic acid.

5. A colored coating composition according to claim 1, comprising 30 to 95 mass % of the hydroxy-containing resin (A) and 5 to 70 mass % of the curing agent (B), based on the total amount of the hydroxy-containing resin (A) and the curing agent (B).

6. A colored coating composition according to claim 1, comprising 1 to 30 parts by mass of the diester compound (C) per 100 parts by mass of the hydroxy-containing resin (A) and the curing agent (B) in total.

7. A colored coating composition according to claim 1, further comprising a urethane emulsion (F) that is substantially free of hydroxy groups.

8. A colored coating composition according to claim 7, comprising 1 to 80 parts by mass of the urethane emulsion (F) per 100 parts by mass of the hydroxy-containing resin (A) and the curing agent (B) in total.

9. A colored coating composition according to claim 1, which is an aqueous coating composition.

10. An article coated with a colored coating composition according to claim 1.

11. A method for forming a multilayer coating film, the method comprising:
(1) applying a colored coating composition according to claim 1 to a substrate to form a first colored coating;
(2) applying a second colored coating composition, which is an aqueous coating composition, to the uncured first colored coating to form a second colored coating; and
(3) heating the uncured first colored coating and the uncured second colored coating to cure both coatings simultaneously.

12. A method according to claim 11, wherein the second colored coating composition comprises a luster pigment (D3).

13. A method according to claim 11, wherein the substrate is a motor vehicle body having an undercoating film formed thereon using an electrodeposition coating composition.

14. An article coated by a method according to claim 11.
